(19) United States
(12) Patent Application Publication
(10) Pub. No.: US 2024/0210531 A1
(43) Pub. Date: Jun. 27, 2024

(54) GATING CAMERA, SENSING SYSTEM, AND VEHICLE LAMP

(71) Applicant: KOITO MANUFACTURING CO., LTD., Tokyo (JP)

(72) Inventors: Shun TANEMOTO, Shizuoka (JP); Masayuki TAKAHASHI, Shizuoka (JP); Koji ITABA, Shizuoka (JP); Daiki KATO, Shizuoka (JP); Masatoshi SUZUKI, Shizuoka (JP)

(73) Assignee: KOITO MANUFACTURING CO., LTD., Tokyo (JP)

(21) Appl. No.: 18/288,516

(22) PCT Filed: Apr. 21, 2022
(86) PCT No.: PCT/JP2022/018484

§ 371 Date: Oct. 26, 2023

(30) Foreign Application Priority Data
Apr. 27, 2021 (JP) 2021-075213
May 10, 2021 (JP) 2021-079976
May 26, 2021 (JP) 2021-088715

(51) Int. Cl. G01S 7/484; B60Q 1/00; B60Q 1/24; G01S 7/486; G01S 17/18; G01S 17/894; G01S 17/931

(52) U.S. Cl. CPC G01S 7/484; B60Q 1/0023; B60Q 1/249; G01S 7/4868; G01S 17/18; G01S 17/894; G01S 17/931

(57) ABSTRACT

The gating camera 20 divides the field of view in the depth-direction into multiple ranges RNG₁ through RNG_{N}, and generates multiple slice images IMGs1 through IMGsN that correspond to the multiple ranges RNG₁ through RNG_{N}. The illumination apparatus 22 is capable of controlling the light emission timing, and emits probe light L1 in synchronization with the light emission timing signal S1. The image sensor 24 is capable of exposure in synchronization with the exposure timing signal S2. The camera controller 26 controls the light emission timing of the illumination apparatus 22 and the image capture timing of the image sensor 24 for each range, and controls the effective image capture range of the image sensor 24 according to the vehicle speed.

### TECHNICAL FIELD The present invention relates to a gating camera.

### BACKGROUND ART

An object identification system that senses the position and the kind of an object existing in the vicinity of the vehicle is used for self-driving or for autonomous control of light distribution of the headlamp. The object identification system includes a sensor and a processing device configured to analyze an output of the sensor. The sensor is selected from among cameras, LiDAR (Light Detection and Ranging, Laser Imaging Detection and Ranging), millimeter-wave radars, ultrasonic sonars, etc., giving consideration to the application, required precision, and cost.

It is not possible to obtain depth information from a typical monocular camera. Therefore, it is difficult to separate a plurality of objects when the plurality of objects positioned at different distances overlap.

As a camera capable of acquiring depth information, a TOF (Time Of Flight) camera is known. The ToF imaging camera is configured to project infrared light by a light emitting device, measure the time of flight until the reflected light returns to the image sensor, and to obtain an image obtained by converting the time of flight into distance information.

An active sensor (hereinafter, referred to as a gating camera in the present specification) that replaces a ToF imaging camera has been proposed (Patent Documents 1 and 2). The gating camera is configured to divide an image capture range into multiple ranges, and to capture an image for each range while changing the exposure timing and the exposure time. This allows a slice image to be acquired for each target range. Each slice image includes only an object included in the corresponding range.

### CITATION LIST

### Patent Literature

Patent Document 1: JP 2009-257981A

Patent Document 2 : International Publication WO2017/110417A1

### SUMMARY OF INVENTION

### Technical Problem

1. The present disclosure has been made in view of such a situation. Accordingly, it is an exemplary purpose of an embodiment of the present disclosure to provide a gating camera that is capable of reducing a data amount.

2. As an output format of the ToF imaging camera, a distance image is used. The distance image is an image with a value obtained by converting the time of flight into the distance information as a pixel value. The distance images of the ToF imaging camera have the same color regardless of the reflection ratio of an object existing at the same distance. Accordingly, for example, in a case in which an image of a sign or the like is captured, information such as characters, figures, or the like written on the sign is lost from the distance image by the ToF imaging camera.

The present disclosure has been made in view of such a situation. Accordingly, it is an exemplary purpose of an embodiment of the present disclosure to provide a sensor that is capable of generating distance image data including more information.

3. The present disclosure has been made in view of such a situation. Accordingly, it is an exemplary purpose of an embodiment of the present disclosure to provide a gating camera that is capable of reducing power consumption.

### Solution To Problem

1. An aspect of the present disclosure relates to a gating camera configured to divide a field of view in the depth direction into multiple ranges, and to generate multiple slice images that correspond to the multiple ranges. The gating camera includes: an illumination apparatus configured to be capable of controlling a light emission timing and to emit probe light; an image sensor configured to be capable of controlling an exposure timing; and a controller configured to control the light emission timing of the illumination apparatus and a timing of image capture by the image sensor for each range, and to control an effective image capture range of the image sensor according to a vehicle speed.

2. A gating camera according to an embodiment of the present disclosure includes: an illumination apparatus configured to be capable of controlling a light emission timing and to emit probe light; an image sensor configured to be capable of controlling an exposure timing; a controller configured to divide the field of view into N (N≥2) ranges in a depth direction, and to control the light emission timing of the illumination apparatus and a timing of image capture by the image sensor for each range; and an image processing device configured to combine the N slice images output by the image sensor corresponding to the N ranges, so as to generate a combined image. The N ranges are assigned N different-color C₁ through C_{N}. Each pixel of the combined image has pixel values obtained by blending N colors C₁ through C_{N} with a coefficient based on the pixel values v₁ through v_{N} of the corresponding pixels of the N slice images.

Another embodiment of the present disclosure relates to an image processing device used together with a gating camera configured to divide the field of view in the depth direction into N ranges, and to output N slice images that correspond to the N ranges. The image processing device is capable of combining the N slice images so as to generate a combined image. N different-number of color C₁ through C_{N} are assigned to the N ranges. Each pixel of the combined image has pixel values obtained by blending N colors C₁ through _{CN} with a coefficient based on the pixel values v₁ through v_{N} of the corresponding pixels of the N slice images.

An aspect of the present disclosure relates to a gating camera structured to divide a field of view in the depth direction into multiple slices, and to generate multiple slice images that correspond to the multiple slices. The gating camera includes: an illumination apparatus configured to emit probe light, the illumination apparatus including multiple light emitting elements, the illumination apparatus being capable of controlling the light distribution of the probe light by selecting the use or non-use of the multiple light emitting elements according to the light distribution control signal; an image sensor configured to be capable of controlling the exposure timing; and a controller configured to: (i) control the light emission timing of the illumination apparatus and the timing of image capture by the image sensor for each range; and (ii) to determine a region to be irradiated with the probe light according to a driving situation, and to generate the light distribution control signal.

Another embodiment of the present disclosure relates to an illumination apparatus. The illumination apparatus is usable for a gating camera configured to divide the field of view in the depth direction into multiple ranges, and to generate multiple slice images that correspond to the multiple ranges. The illumination apparatus includes: multiple light emitting elements arranged in an array; an optical system configured to project the output light output from each of the multiple light emitting elements onto a corresponding one from among the multiple regions on a virtual vertical screen; and a lighting circuit configured to be capable of selectively driving the multiple light emitting elements and to be capable of controlling the driving timings of the multiple light emitting elements according to the light emission timing signal.

### Advantageous Effect of the Invention

According to an aspect of the present disclosure, it is possible to reduce the amount of data. Also, according to another aspect, the distance image including more information than the distance image generated by the ToF sensor can be generated. According to yet another aspect of the present disclosure, it is possible to reduce power consumption of the gating camera.

### BRIEF DESCRIPTION OF DRAWINGS

FIG. 1 is a block diagram showing a gating camera according to a first embodiment.

FIG. 2 is a diagram for explaining the basic operation of the gating camera.

FIGS. 3A and 3B are diagrams for explaining slice images generated by the gating camera.

FIGS. 4A through 4C are diagrams for explaining the control of the image capture range (angle of view) according to the vehicle speed.

FIG. 5 is a diagram showing a vehicle traveling on a curve.

FIGS. 6A and 6B are diagrams showing a vehicle traveling on a straight road.

FIG. 7 is a block diagram showing a gating camera according to a second embodiment.

FIG. 8 is a diagram for explaining the basic operation of the gating camera.

FIGS. 9A and 9B are diagrams for explaining slice images generated by the gating camera.

FIGS. 10A through 10D are diagrams for explaining the combined image and the conventional distance image.

FIG. 11 is a diagram for explaining multiple colors assigned to multiple ranges in the RGB color system.

FIG. 12 is a diagram for explaining the combining of the combined images IMGc. FIG. 13 is a diagram for explaining combining processing in a case in which the same object is captured across multiple slice images.

FIG. 14 is a diagram showing an example of the correspondence relation between multiple ranges and colors in Example 2.1.

FIG. 15 is a diagram for explaining multiple colors assigned to multiple ranges in the Yxy color system.

FIG. 16 is a diagram showing an example of the correspondence relation between multiple ranges and colors in Example 2.2.

FIG. 17 is a diagram showing an example of the correspondence relation between multiple ranges and colors in Example 2.3.

FIG. 18 is a diagram showing an example of the correspondence relation between multiple ranges and colors in Example 2.3.

FIG. 19 is a block diagram showing a gating camera according to a third embodiment.

FIG. 20 is a diagram for explaining the basic operation of the gating camera.

FIGS. 21A and 21B are diagrams for explaining slice images generated by the gating camera.

FIGS. 22A through 22C are diagrams for explaining an example of the control of the illumination region according to the driving situation.

FIGS. 23A through 23C are diagrams for explaining another example of the control of the illumination region according to the driving situation.

FIG. 24 is a diagram for explaining light distribution control by the camera controller.

FIG. 25 is a diagram for explaining the change of the horizontal field of view while the vehicle is traveling on the curve.

FIG. 26 is a diagram showing a configuration example of an illumination apparatus.

FIG. 27 is a block diagram showing the sensing system.

FIGS. 28A and 28B are diagrams showing an automobile provided with the gating camera.

FIG. 29 is a block diagram showing a vehicle lamp provided with the sensing system.

### DESCRIPTION OF EMBODIMENTS

### Summary of Embodiments

Description will be made regarding a summary of some exemplary embodiments of the present disclosure. The summary is provided as a prelude to the detailed description that will be described later, and is intended to simplify the concepts of one or more embodiments for the purpose of basic understanding of the embodiments. It is not intended to limit the scope of the present invention or the disclosure. This summary is not an extensive overview of all contemplated embodiments. It is intended to neither identify key elements of all embodiments nor delineate the scope of some or all aspects. For convenience, “an embodiment” may be used to refer to a single embodiment (example or modification) or multiple embodiments (examples or modifications) disclosed in this specification.

1. The gating camera according to an embodiment divides the field of view in the depth direction into multiple ranges, and generates multiple slice images that correspond to the multiple ranges. The gating camera includes: an illumination apparatus configured to be capable of controlling the light emission timing and to emit probe light; an image sensor configured to be capable of controlling the exposure timing; and a controller configured to control the light emission timing of the illumination apparatus and the timing of image capture by the image sensor for each range, and to control the effective image capture range of the image sensor according to the vehicle speed.

In a driving situation in which the vehicle speed is high, the importance of the information with respect to an object existing on the side of the road deteriorates. Accordingly, in a case in which the vehicle speed is high, the effective image capture range of the image sensor is reduced. This allows the number of pixels to be reduced, thereby allowing the data amount of the slice image to be reduced.

Furthermore, since the effective image capture range of the image sensor is reduced, this allows the power consumption of the read-out circuit to be reduced. Furthermore, this allows the time required to transmit the slice image to be reduced, thereby allowing the frame rate to be raised.

With an embodiment, the controller may acquire a stop distance that corresponds to the vehicle speed, and may determine the effective image capture range of the image sensor based on the stop distance and the minimum radius of the curve existing on the road on which the vehicle is currently traveling. This arrangement is capable of preventing a collision with an object even if braking is started after an object in front of the vehicle is detected by the gating camera.

With an embodiment, when the stop distance is represented by L and the minimum radius is represented by R, the effective image capture range of the image sensor may be controlled such that the half-angle of view (unit rad) of the gating camera is included within a range with L/(2R) as the lower limit.

In an embodiment, the controller may acquire the stop distance that corresponds to the vehicle speed. In a case the vehicle is traveling on a straight road, when the stop distance is L, the effective image capture range of the image sensor may be controlled such that the half angle of view (unit rad) of the gating camera is included within a range with arcsin (x/L) as the lower limit, with x which is a variable or a constant.

In an embodiment, the stop distance may be calculated using the road surface state as a parameter.

With an embodiment, the control of the effective image capture range of the image sensor based on the vehicle speed may be effective on an expressway. With such an arrangement, the effective image capture range is increased regardless of the vehicle speed. This allows a pedestrian or the like on the side of the road to be reliably detected.

2. A gating camera according to an embodiment includes: an illumination apparatus configured to be capable of controlling the light emission timing and to emit probe light; an image sensor configured to be capable of controlling exposure timing; a controller configured to divide the field of view into N (N≥2) ranges in the depth direction, and to control the light emission timing of the illumination apparatus and the timing of image capture by the image sensor for each range; and an image processing device configured to combine the N slice images output by the image sensor corresponding to the N ranges, so as to generate a combined image. N different-number of color C₁ through C_{N} are assigned to the N ranges. Each pixel of the combined image has pixel values obtained by weighting and adding the N colors C₁ through C_{N} by a coefficient based on the pixel values v₁ through v_{N} of the corresponding pixels of the N slice images, respectively.

With this configuration, in the combined image, the range (i.e., distance) including the object is represented by the color system. The reflection ratio of the object is represented by the brightness of the colors in the same system. This allows objects or regions having different reflectances existing in the same range to be identified.

In an embodiment, in the RGB color system, the i-th color (Rᵢ, Gᵢ, Bᵢ) and the (i+1)-th color (Rᵢ₊₁, Gᵢ₊₁, Bᵢ₊₁) may have different values for one element from among R, G, and B, and may have the same value for the remaining two elements. The pixel values (R, G, B) of the respective pixels of the combined image may be represented by (R, G, B)=Σ_{j=1:N}[vⱼ·(Rⱼ, Gⱼ, Bⱼ)]. The Σ_{j=1:N} N represents the total sum when j is changed from 1 to N. This allows the combined image to be calculated with extremely simple calculation processing.

In an embodiment, the i-th color may be defined as (xᵢ, yᵢ) in the xy chromaticity diagram. The pixel values of the Yxy color system of each pixel of the combined image may be represented by (Y, x, y)=(Σ_{j=1:N}(vⱼ), Σ_{j=1:N}(vⱼ·xⱼ)/Σ_{j=1:N}vⱼ, Σ_{j=1:N}(vⱼ·yⱼ)/Σ_{j=1:N}vⱼ) in the Yxy color system.

In an embodiment, the N colors may be determined so as to have different hues H in the HSV color system. The pixel values (H, S, V) of the respective pixels of the combined image may be represented by (H, S, V)=(Σ_{j=1:N}(vⱼ·Hⱼ)/Σ_{j=1:N}vⱼ, S₀, Σ_{j=1:N}(vⱼ)) with the S₀ as a constant. In an embodiment, the image sensor may be configured as a monochrome sensor.

In an embodiment, the image sensor may be a color sensor. In this case, the blending coefficient may be the brightness of the pixel values of the color image.

The gating camera according to an embodiment divides the field of view in the depth direction into multiple slices, and generates multiple slice images that correspond to the multiple slices. The gating camera includes: an illumination apparatus configured to emit probe light, the illumination apparatus including multiple light emitting elements, the illumination apparatus being capable of controlling the light distribution of the probe light by selecting the use or non-use of the multiple light emitting elements according to the light distribution control signal; an image sensor configured to be capable of controlling the exposure timing; and a controller configured to: (i) control the light emission timing of the illumination apparatus and the timing of image capture by the image sensor for each range; and (ii) to determine a region to be irradiated with the probe light according to a driving situation, and to generate the light distribution control signal.

With this configuration, in a region in which no object is to be detected or a region in which an object present in the region is unlikely to have an effect on the driving of the own vehicle, the emission of the probe light is stopped, thereby allowing the power consumption to be reduced.

In an embodiment, the controller may exclude a region that corresponds to a sky region from the region to be irradiated with the probe light.

In an embodiment, the controller may exclude a region outside the road from the region to be irradiated with the probe light.

In an embodiment, the controller may select all the regions as the regions to be irradiated with the probe light in the reference frame. The controller may determine the regions to be irradiated with the probe light in m (m≥1) normal frames following the reference frame based on multiple slice images acquired in the reference frame.

In an embodiment, the controller may judge an area in which the pixel values are smaller than a predetermined threshold value in all the slice images captured in the reference frame, as a region that corresponds to sky. This allows a sky portion to be detected.

In an embodiment, the controller may select the region to be irradiated with the probe light based on the three-dimensional map information.

In an embodiment, the controller may dynamically control m, which is an interval at which the reference frame is generated, according to the road situation.

In an embodiment, the controller may reduce m in the vicinity of a slope. In the vicinity of a slope, the proportion of sky included in the field of view of the camera changes greatly and frequently. Accordingly, in such a situation, by reducing m and frequently updating the light distribution of the probe light, appropriate sensing is enabled.

In an embodiment, the controller may control the occurrence intervals of the reference frames based on the radius of curvature of the curve during traveling on the curve.

Description will be made with reference to the drawings regarding a preferred embodiment of the present invention. The same or similar components, members, and processes are denoted by the same reference numerals, and redundant description thereof will be omitted as appropriate. The embodiments have been described for exemplary embodiments, and are by no means intended to restrict the present invention. In addition, it is not necessarily essential for the present invention that all the features or a combination thereof be provided as described in the embodiments.

### First Embodiment

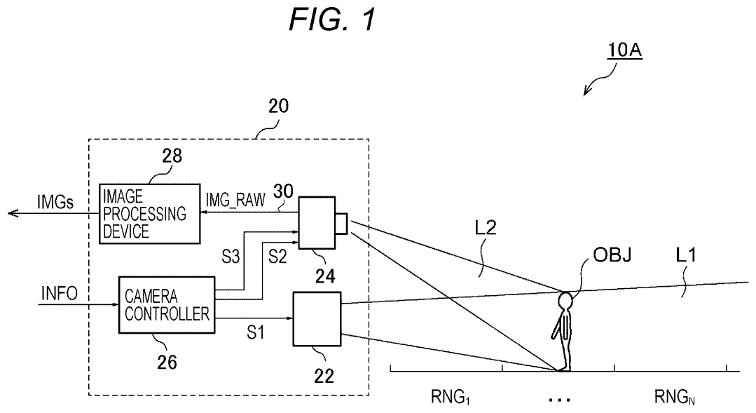

FIG. 1 is a block diagram showing a gating camera 20A according to an embodiment 1. The gating camera 20A is mounted on a vehicle such as an automobile, motorcycle, or the like. The output of the gating camera 20A is used to judge the kind (category or class) of an object OBJ that exists in the vicinity of the vehicle.

The gating camera 20A includes an illumination apparatus (light projector) 22, an image sensor 24, and a camera controller 26. The gating camera 20A captures images for a plurality of N (N≥2) ranges RNG₁ through RNG_{N} divided in the depth direction. The ranges may be designed such that adjacent ranges overlap at their boundaries in the depth direction.

The illumination apparatus 22 emits pulsed illumination light L1 in front of the vehicle in synchronization with a light emission timing signal S1 supplied from the camera controller 26. As the pulsed illumination light L1, infrared light is preferably employed. However, the present invention is not restricted to such configuration. Also, as the pulsed illumination light L1, visible light or ultraviolet light having a predetermined wavelength may be employed. As the illumination apparatus 22, for example, a laser diode (LD) or an LED can be used.

The image sensor 24 includes multiple light-receiving pixels px, is capable of exposure control in synchronization with the exposure timing signal S2 supplied from the camera controller 26, and generates an raw image (RAW image) including multiple pixels. The image sensor 24 is sensitive to the same wavelength as that of the pulsed illumination light L1. The image sensor 24 captures an image of reflected light (returned light) L2 reflected by the object OBJ. The slice image IMGᵢ generated by the image sensor 24 with respect to the i-th range RNGᵢ is referred to as a raw image or a primary image as needed, and is distinguished from the slice image IMGsᵢ that is the final output of the gating camera 20A.

Furthermore, the image sensor 24 is configured to be capable of controlling an effective image capture range according to an image capture range control signal S3 output from the camera controller 26. As the effective image capture range becomes smaller, the effective angle of view becomes smaller.

The camera controller 26 controls the illumination timing (light emission timing) of the probe light L1 by the illumination apparatus 22 and the exposure timing by the image sensor 24. Specifically, the camera controller 26 is implemented as a combination of a processor (hardware component) such as CPU (Central Processing Unit), MPU (Micro Processing Unit), microcontroller, or the like, and a software program to be executed by the processor (hardware component).

The image processing device 28 receives the raw image IMG_RAWᵢ generated by the image sensor 24, and performs required image processing so as to generate slice-image IMGsᵢ. The slice image IMGs may be the same as that of the raw image IMG_RAW. In this ase, the image processing device 28 may be omitted.

The camera controller 26 receives the vehicle information INFO including at least the vehicle speed information from the vehicle main body side. The camera controller 26 controls the effective image capture range of the image sensor 24 according to the vehicle speed indicated by the vehicle information INFO. Specifically, as the vehicle speed becomes lower, the angle of view becomes wider, and as the vehicle speed becomes higher, the angle of view becomes smaller. Accordingly, the image capture range control signal S3 is output so as to control the effective image capture range.

The above is the configuration of the gating camera 20A. Next, description will be made regarding the operation of the sensing system 400.

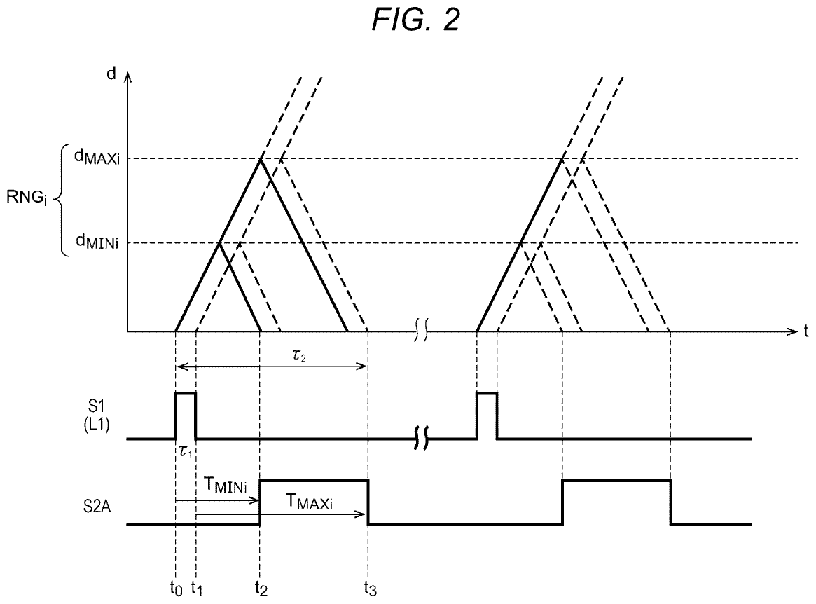

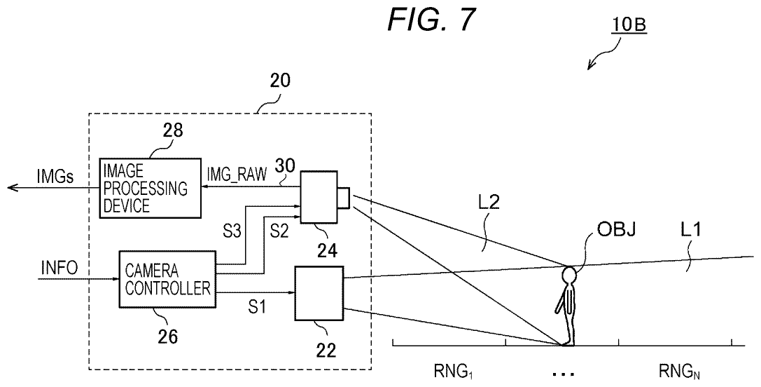

FIG. 2 is a diagram for explaining the basic operation of the gating camera 20A. FIG. 2 shows the operation when the i-th range RNGᵢ is sensed as a range of interest (ROI: Range Of Interest). The illumination apparatus 22 emits light during a light-emitting period τ₁ from the time points tₒ to t₁ in synchronization with the light emission timing signal S1. In the upper diagram of FIG. 7, a light beam diagram is shown with the horizontal axis as time and with the vertical axis as distance. The distance between the gating camera 20A and the near-distance boundary of the range RNGᵢ is represented by d_{MINi}. The distance between the gating camera 20A and the far-distance boundary of the range RNGᵢ is represented by d_{MAXi}.

The round-trip time T_{MINi}, which is a period from the departure of light from the illumination apparatus 22 at a given time point, to the arrival of the light at the distance d_{MINi}, up to the return of the reflected light to the image sensor 24, is represented by T_{MINi}=2×d_{MINi}/c. Here, c represents the speed of light. Similarly, the round-trip time T_{MAXi}, which is a period from the departure of light from the illumination apparatus 22 at a given time point, to the arrival of the light at the distance d_{MAXi}, up to the return of the reflected light to the image sensor 24, is represented by T_{MAXi}=2×d_{MAXi}/c.

When only an image of an object OBJ included in the range RNGᵢ is to be captured, the camera controller 26 generates the exposure timing signal S2 so as to start the exposure at the time point t₂=t₀+T_{MINi}, and so as to end the exposure at the time point t₃=t₁+T_{MAXi}. This is a single exposure operation.

When an image is captured for the i-th range RNGᵢ, multiple sets of light emission and exposure may be executed, and the pixels of the image sensor 24 may be integrated with the charges so as to generate a bright image. In this case, preferably, the camera controller 26 may repeatedly generate the light emission timing signal S1 and the exposure timing signal S2 with a predetermined period.

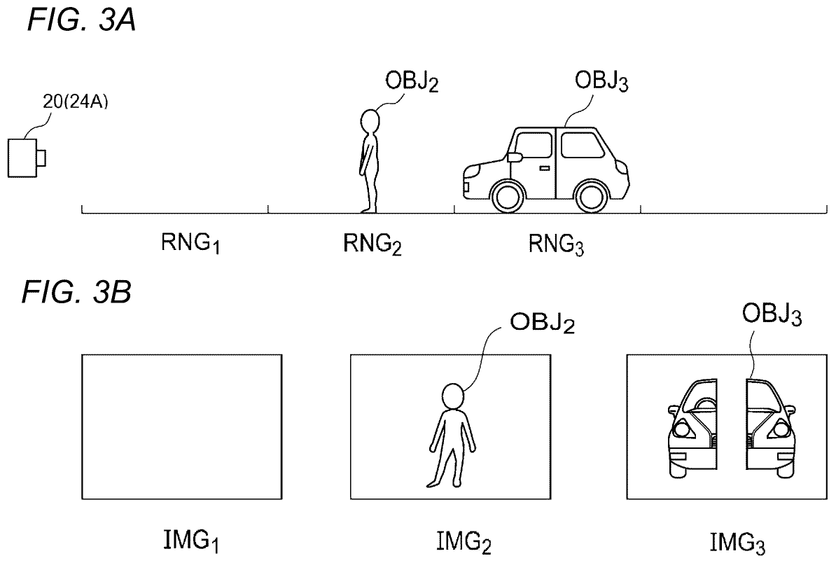

FIGS. 3A and 3B are diagrams for explaining slice images generated by the gating camera 20A. FIG. 3A shows an example in which an object (pedestrian) OBJ₂ exists in the range RNG₂, and an object (vehicle) OBJ₃ exists in the range RNG₃. FIG. 3B shows multiple range images IMG₁ through IMG₃ acquired in the situation shown in FIG. 3A. When the slice image SIMG₁ is captured, the image sensor is exposed by only the reflected light from the range RNG₁. Accordingly, the image SIMG₁ includes no object image.

Similarly, when the slice image SIMG₂ is captured, the image sensor is exposed by only the reflected light from the range RNG₂. Accordingly, the slice image SIMG₂ includes only the object OBJ₂. Similarly, when the slice image IMG₃ is captured, the image sensor is exposed by only the reflected light from the range RNG₃. Accordingly, the slice image IMG₃ includes only the object OBJ₃. As described above, with the gating camera 20, objects are separated and captured for the respective ranges.

Next, description will be made regarding the dynamic control of the image capture range of the gating camera 20A.

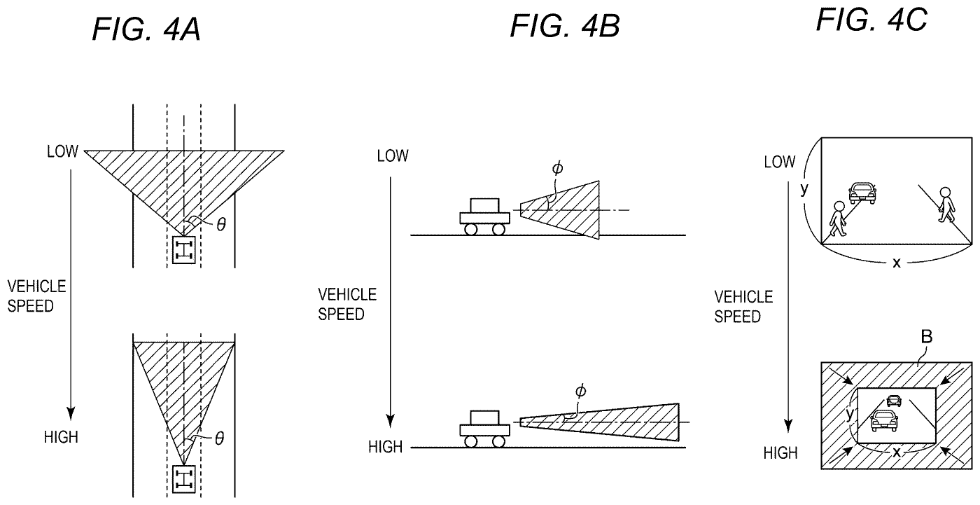

FIGS. 4A through 4C are diagrams for explaining the control of the image capture range (angle of view) according to the vehicle speed. FIG. 4A shows the horizontal angle of view. FIG. 4B shows the vertical angle of view. FIG. 4C shows the effective image capture range of the image sensor.

As shown in the upper part of FIGS. 4A and 4B, during low-speed driving, it is necessary to recognize a pedestrian or another vehicle at a near distance. Accordingly, an image of a wide region including the road side is required. Accordingly, both the half angle of view θ in the horizontal direction and the half angle of view φ in the vertical direction are set to be wide. Specifically, as shown in the upper part of FIG. 4C, the effective image capture range A of the image sensor is widely set so as to include all the pixels of the image sensor. The half angle of view θ in the horizontal direction is determined corresponding to the number of pixels x in the horizontal direction. The half angle of view φ in the vertical direction is determined corresponding to the number of pixels y in the vertical direction.

As shown in the lower part of FIGS. 4A and 4B, when the vehicle is traveling on an expressway or an automobile dedicated road (during high-speed driving), the importance of a pedestrian at a near distance or another vehicle at a near distance is reduced, resulting in an increased importance of an object at a far distance. Accordingly, this reduces the need to capture an image of a wide region including the road side. Accordingly, both the half angle of view θ in the horizontal direction and the half angle of view φ in the vertical direction are set to be narrow. Specifically, as shown in the lower stage in FIG. 4C, the region B around the image sensor 24 is disabled. With such an arrangement in which only the central portion is cropped (trimmed), the effective image capture range A is narrowed, thereby setting the field of view to be narrow.

Next, description will be made regarding a specific example of the relation between the image sensor 24, the effective image capture range (angle of view) and the vehicle speed.

The camera controller 26 may acquire a stop distance L that corresponds to the vehicle speed v, and may determine the effective image capture range of the image sensor 24 based on the stop distance L and the minimum radius R of the curve existing on the road on which the vehicle is currently traveling. With this, even if braking is started after an object in front of the vehicle is detected by the gating camera 20A, this arrangement is capable of preventing a collision with an object.

The stop distance L can be calculated as the sum of the idle distance La and the braking distance Lb from Expression (1).

$$L = La + Lb \qquad ( 1 )$$

The idle distance La can be calculated by Expression (2).

$$La = {t}_{RES} \times v \qquad ( 2 )$$

t_{RES} represents the response time. v is the vehicle speed.

The braking distance Lb can be calculated by, for example, Expression (3).

$$Lb = {v}^{′2} / ( 254 \times μ ) \qquad ( 3 )$$

v′ represents the vehicle speed immediately before braking, and u represents the friction coefficient. The friction coefficient u varies depending on the state of the road surface. For example, μ=0.7 for dry asphalt or concrete, 0.5 for wet asphalt or concrete, 0.15 for hardened snow, and 0.07 for ice.

When the stop distance L is acquired, the calculation may be executed giving consideration to the road surface state. This allows a precise braking distance Lb to be obtained. In a case in which the road surface state is not considered, the braking distance may be calculated assuming that the friction coefficient μ is constant.

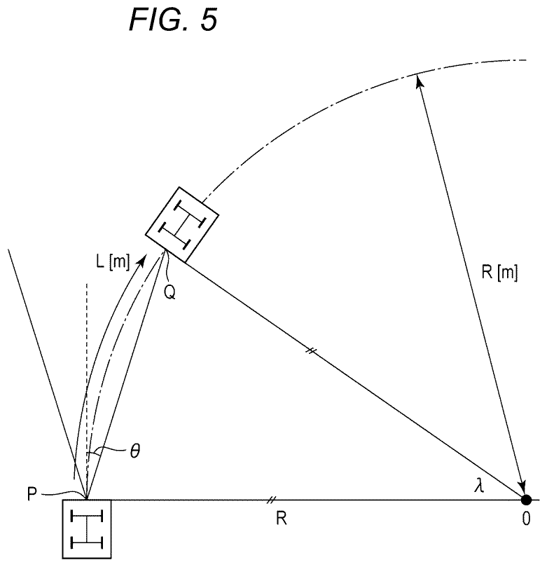

FIG. 5 is a diagram showing a vehicle traveling on a curve. Description will be made assuming that braking is started at the point P while the vehicle is traveling on a curve having a radius of curvature R with the point O as the center. The actual curve is a crocoid curve. However, for the purpose of simplifying the calculation, description will be made assuming that the actual curve is an arc. When the stop distance is L, the angle λ(rad) formed by the straight line OP and OQ satisfies λ·R=L. Accordingly, in the drawing, the angle λ is represented by λ=L/R(rad). In this case, the angle θ from the point P to the stop position Q is represented by θ=λ/2=L/(2R) (rad). Accordingly, when the half-angle of view of the gating camera 20A is set to be equal to or larger than the angle θ, this allows an object positioned farther than the stop point Q to be detected. That is to say, the effective image capture range of the image sensor 24 is controlled such that the half-angle of view (unit rad) falls within a range with L/(2R) as the lower limit.

For example, the half-angle of view θ of the gating camera 20A may be determined to be wider than L/(2R) and smaller than 1.2×L/(2R). In a case in which the coefficient α (1≤α≤1.2) is satisfied, the half-angle of view θ may be determined according to Expression (4).

$$θ = α \times L / ( 2 R ) \qquad ( 4 )$$

In a case in which the vehicle is traveling on dry asphalt at a speed of 100 km/h, the stop distance L is 77 m. In this case, assuming that the curve is R=400 m, the half-angle of view may preferably be 5.52 degrees or more. R=400 m is the minimum radius expected for a road with a speed limit of 100 km/h.

In a case in which the vehicle is traveling on wet asphalt at a speed of 100 km/h, the stop distance L extends to 99 m. In this case, assuming that the curve is R=400 m, the half-angle of view may preferably be 7.13 degrees or more.

In a case in which the vehicle is traveling on the road covered with snow at a speed of 60 km/h, the stop distance L extends to 107 m. In this case, assuming that the curve is R=400 m, the half-angle of view may preferably be 7.66 degrees or more.

In a case in which the vehicle is traveling on dry asphalt at a speed of 120 km/h, the stop distance L is 106 m. In this case, assuming that the curve is represented by R=710 m, the half-angle of view may preferably be set to 4.28 degrees or more. R=710 m is the minimum radius expected for a road with a speed limit of 120 km/h.

Description has been made above regarding an arrangement in which a half angle of view is determined based on a curve with a minimum radius assumed for a road on which the vehicle is currently traveling. However, the present invention is not restricted to such an arrangement. The half angle of view θ may be controlled based on Expression (4) using the radius of curvature R and the braking distance L of the curve on which the vehicle is traveling.

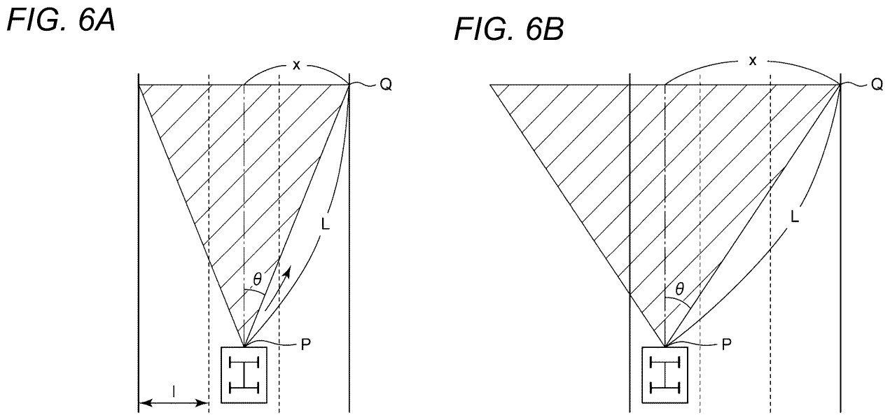

The half angle of view θ may be determined for the curve and the straight road based on different calculation expressions. Description will be made below regarding an example of the control operation for a straight road having multiple lanes on one side. FIGS. 6A and 6B are diagrams showing a vehicle traveling on a straight road. FIGS. 6A and 6B assume that the vehicle is operated as a three-lane road on one side. Description will be made with the width of one lane as 1, and with the stop distance as L. FIG. 6A shows the vehicle traveling in the left lane. FIG. 6B shows the vehicle traveling in the central lane.

The distance in the horizontal direction from the own vehicle to the end of the road in the horizontal direction is represented by x. In the situation shown in FIG. 6A, x=1.5×1. In the situation shown in FIG. 6B, x=2.5×1. The angle θ from the own vehicle to an object existing at the point Q of the road end at the stop distance L is represented by θ=arcsin (x/L). Accordingly, when the half-angle of view of the gating camera 20A is set to be equal to or larger than the angle θ, this allows an object positioned farther than the stop point Q to be detected. For example, the half-angle of view θ of the gating camera 20A may be determined to be wider than arcsin (x/L) and smaller than 1.2 xarcsin (x/L). In a case in which the coefficient β(1≤β≤1.2) is satisfied, the half-angle of view θ may be determined according to Expression (5).

$$θ = β \times arcsin ( x / L ) \qquad ( 5 )$$

As shown in FIG. 6A, when the vehicle is traveling on dry asphalt at a speed of 100 km/h, the stop distance L is 77 m. Assuming that 1=3.5 m, x=3.5×1.5. The half angle of view θ may preferably be determined to be θ≥ sin⁻¹ (3.5×1.5/77)=0.06817 (rad)=3.906 (deg).

As shown in FIG. 6B, in a case in which the vehicle is traveling on snowfall at a speed of 60 km/h, the stop distance L is 107 m. Assuming that 1=3.5 m, x=3.5×2.5. The half angle of view θ may preferably be determined to be θ≥ sin⁻¹ (3.5×2.5/107)=0.08188 (rad)=4.691 (deg).

It should be noted that, since the distance x is determined using the driving lane of the own vehicle as a parameter, it is also assumed that the camera controller 26 is not easy to acquire the distance x. In this case, regardless of the actual driving lane, assuming that the vehicle is driving on the end lane line as shown in FIG. 6A, the distance x may be acquired, and the half angle of view θ may be calculated from the following Expression (5). The number of lanes and the width of the lane may be acquired from the car navigation system. Otherwise, they may be acquired from the outside of the vehicle by wireless communication.

Alternatively, in consideration of various assumed roads, a typical distance x may be determined as a constant value. The distance x may be stored in the camera controller 26.

Description will be made assuming that the half-angle of view when the effective image capture range of the image sensor 24 is maximized is 12.8 degrees. In consideration of various vehicle speeds and road surface conditions, the half-angle of view changes within a range of 4 degrees to 10 degrees, which is 30 to 80% of the original half-angle of view. In a case in which the pixels are cropped at the same ratio not only in the horizontal direction but also in the vertical direction, the number of pixels becomes 30%×30% to 80% to 80%=9% to 64%, indicating that the data amount can be drastically reduced.

Description will be made regarding modifications relating to Example 1.

### Modification 1.1

Description has been made in the embodiment regarding an arrangement in which, for two axes in the horizontal direction and the vertical direction, an effective image capture range (angle of view) is controlled according to the vehicle speed. However, the present invention is not restricted to such an arrangement. Also, the angle of view/the effective image capture range may be changed only in the horizontal direction.

### Modification 1.2

Description has been made in the embodiment regarding an arrangement in which, for each of the curve and the straight road, the effective image capture range is controlled according to the vehicle speed. However, the present invention is not restricted to such an arrangement. For example, with respect to the curve, the control of the effective image capture range based on the vehicle speed may be disabled, the effective image capture range may be fixed to the maximum value, and the effective image capture range may be controlled based on the vehicle speed only on a straight road.

### Modification 1.3

In the embodiment, in the curve, the effective image capture range (angle of view) is controlled based on the first relational expression f(v) with the vehicle speed v as an argument. In the straight road, the effective image capture range (angle of view) is controlled based on a different second relational expression g(v). Expression (4) can be said to be an example of the relational expression f(v). Expression (5) can be said to be an example of the relational expression g(v). In Expressions (4) and (5), L represents a function of v.

In a modification 1.3, control of the effective image capture range, i.e., the angle of view, may be executed based on the common relational expression h(v) with at least the vehicle speed v as an argument. In this case, the relational expression h(v) may preferably be determined so as to satisfy h(v)≥max(f(v), g(v)). Here, max ( ) is a function that indicates the larger one.

### Modification 1

In a case in which the half-angle of view is determined based on the same calculation expression for the general road and the expressway, such an arrangement may lead to an undesirable situation. In this case, different parameters (e.g., α in Expression (4), β, x in Expression (5)) may be defined for the general road and the expressway.

Alternatively, on a general road, the control of the effective image capture range based on the vehicle speed may be disabled, and the effective image capture range may be fixed to the maximum value.

### Second Embodiment

FIG. 7 is a block diagram showing a gating camera 20B according to an embodiment 2. The gating camera 20B is mounted on a vehicle such as an automobile, motorcycle, or the like. The output of the gating camera 20B is used to judge the kind (category or class) of an object OBJ that exists in the vicinity of the vehicle.

The gating camera 20B includes an illumination apparatus (light projector) 22, an image sensor 24, a camera controller 26, and an image processing device 28. The gating camera 20B captures images for a plurality of N (N≥2) ranges RNG₁ through RNG_{N} divided in the depth direction. The ranges may be designed such that adjacent ranges overlap at their boundaries in the depth direction.

The illumination apparatus 22 emits pulsed illumination light L1 in front of the vehicle in synchronization with a light emission timing signal S1 supplied from the camera controller 26. As the pulsed illumination light L1, infrared light is preferably employed. However, the present invention is not restricted to such configuration. Also, as the pulsed illumination light L1, visible light or ultraviolet light having a predetermined wavelength may be employed. As the illumination apparatus 22, for example, a laser diode (LD) or an LED can be used.

The image sensor 24 includes multiple light-receiving pixels px, is capable of exposure control in synchronization with the exposure timing signal S2 supplied from the camera controller 26, and generates an raw image (RAW image) including multiple pixels. The image sensor 24 is sensitive to the same wavelength as that of the pulsed illumination light L1. The image sensor 24 captures an image of reflected light (returned light) L2 reflected by the object OBJ. Description will be made regarding an arrangement in which the image sensor 24 is configured as a monochrome IR sensor.

The camera controller 26 controls the illumination timing (light emission timing) of the probe light L1 by the illumination apparatus 22 and the exposure timing by the image sensor 24. Specifically, the camera controller 26 is implemented as a combination of a processor (hardware component) such as CPU (Central Processing Unit), MPU (Micro Processing Unit), microcontroller, or the like, and a software program to be executed by the processor (hardware component).

The image processing device 28 receives the raw image IMG_RAWᵢ generated by the image sensor 24, and performs required image processing so as to generate slice-image IMGsᵢ. The raw image IMG_RAW generated in each range may be used as it is as the slice image IMGs.

Also, the image processing device 28 combines the multiple slice images IMGs₁ through IMGs_{N} (or IMG_RAW₁ through IMG_RAW_{N}), so as to generate a combined image IMGc.

Description will be made below regarding the generation of the combined image IMGc by the image processing device 28.

N different color C₁ through C_{N} are assigned to the N ranges RNG₁ through RNG_{N}.

Each pixel of the combined image IMGc has pixel values obtained by weighting and adding the N colors C₁ through C_{N} by a coefficient based on the pixel values v₁ to v_{N} of the corresponding pixels of the N slice images IMGs₁ through IMGs_{N}, respectively.

The above is the configuration of the gating camera 20B. Next, description will be made regarding the operation of the sensing system 400.

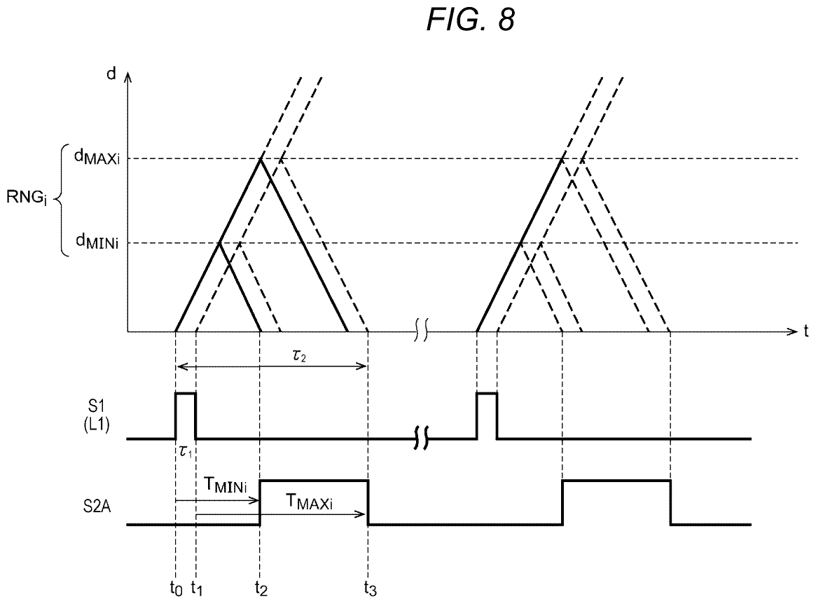

FIG. 8 is a diagram for explaining the basic operation of the gating camera 20B. FIG. 8 shows the operation when the i-th range RNGᵢ is sensed as a range of interest (ROI: Range Of Interest). The illumination apparatus 22 emits light during a light-emitting period τ₁ from the time points tₒ to t₁ in synchronization with the light emission timing signal S1. In the upper diagram of FIG. 7, a light beam diagram is shown with the horizontal axis as time and with the vertical axis as distance. The distance between the gating camera 20 and the near-distance boundary of the range RNGᵢ is represented by d_{MINi}. The distance between the gating camera 20 and the far-distance boundary of the range RNGᵢ is represented by d_{MAXi}.

The round-trip time T_{MINi}, which is a period from the departure of light from the illumination apparatus 22 at a given time point, to the arrival of the light at the distance d_{MINi}, up to the return of the reflected light to the image sensor 24, is represented by T_{MINi}=2×d_{MINi}/c. Here, c represents the speed of light.

Similarly, the round-trip time T_{MAXi}, which is a period from the departure of light from the illumination apparatus 22 at a given time point, to the arrival of the light at the distance d_{MAXi}, up to the return of the reflected light to the image sensor 24, is represented by T_{MAXi}=2×d_{MAXi}/c.

When only an image of an object OBJ included in the range RNGᵢ is to be captured, the camera controller 26 generates the exposure timing signal S2 so as to start the exposure at the time point t₂=t₀+T_{MINi}, and so as to end the exposure at the time point t₃=t₁+T_{MAXi}. This is a single exposure operation.

When an image is captured for the i-th range RNGᵢ, multiple sets of light emission and exposure may be executed, and the pixels of the image sensor 24 may be integrated with the charges so as to generate a bright image. In this case, preferably, the camera controller 26 may repeatedly generate the light emission timing signal S1 and the exposure timing signal S2 with a predetermined period.

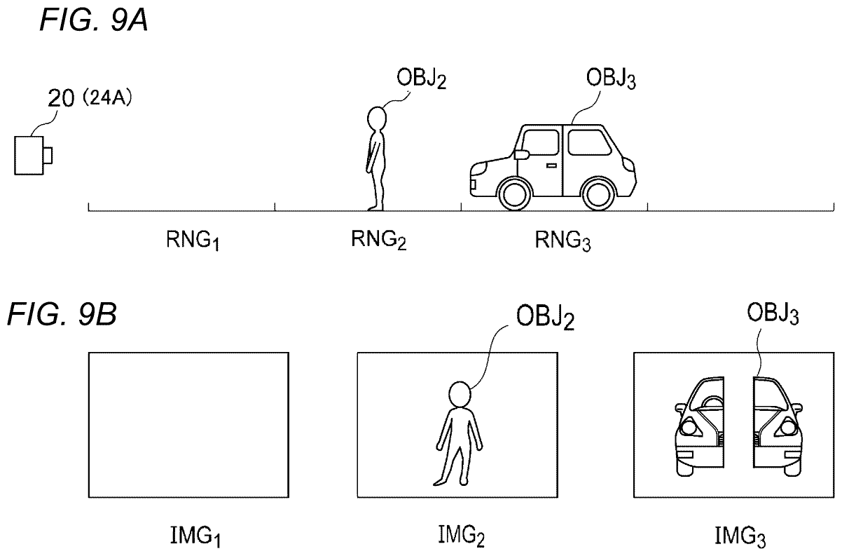

FIGS. 9A and 9B are diagrams for explaining slice images generated by the gating camera 20B. FIG. 9A shows an example in which an object (pedestrian) OBJ₁ exists in the range RNG₁, and an object (vehicle) OBJ₃ exists in the range RNG₃. FIG. 9B shows multiple range images IMG₁ through IMG₃ acquired in the situation shown in FIG. 9A. When the slice image SIMG₁ is captured, the image sensor is exposed by only the reflected light from the range RNG₁. Accordingly, the image SIMG₁ includes no object image.

Similarly, when the slice image SIMG₂ is captured, the image sensor is exposed by only the reflected light from the range RNG₂. Accordingly, the slice image SIMG₂ includes only the object OBJ₂. Similarly, when the slice image IMG₃ is captured, the image sensor is exposed by only the reflected light from the range RNG₃. Accordingly, the slice image IMG₃ includes only the object OBJ₃. As described above, with the gating camera 20, objects are separated and captured for the respective ranges.

Next, description will be made regarding the generation of the combined image IMGc by the image processing device 28.

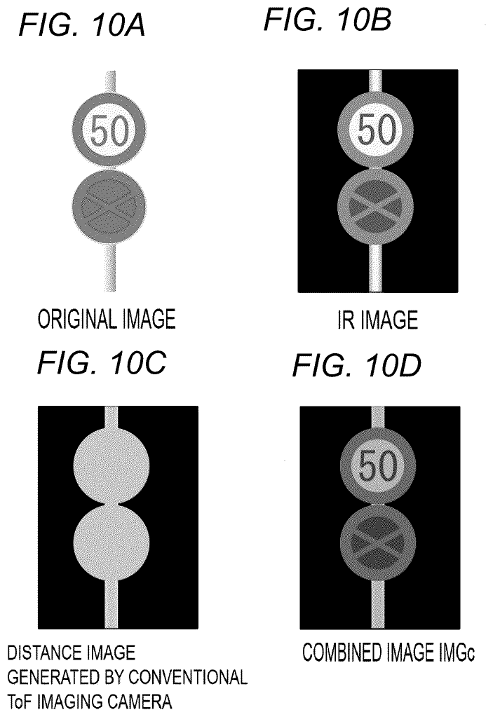

FIGS. 10A through 10D are diagrams for explaining the combined image and the conventional distance image. FIG. 10A shows an actual field of view. FIG. 10B shows an IR image obtained by capturing an image of the field of view shown in FIG. 10A. FIG. 10C shows a distance image generated by a conventional ToF imaging camera. FIG. 10D shows a combined image IMGc generated in the present embodiment.

As shown in FIG. 10C, as the distance images generated by a conventional ToF imaging camera, an object (in this example, a sign) that exists at the same distance is represented by the same color. Accordingly, as shown in FIG. 10B, this leads to the loss of the information with respect to the characters and figures included in the IR image.

In contrast, the combined image IMGc according to the present embodiment includes characters and figures written on the surface of an object that exists in the same range. Accordingly, by the image processing in the subsequent stage, more detailed information for the object can be acquired based on the combined image IMGc. Alternatively, by displaying the combined image IMGc on the display, this allows the user to recognize the kind of the sign or the instruction.

Description will be made below regarding a specific example of a method for generating the combined image IMGc.

### Example 2.1

In an example 2.1, combining processing is executed using the RGB color system. Multiple colors (R₁, G₁, B₁) through (R_{N}, G_{N}, B_{N}) are assigned corresponding to the multiple ranges RNG₁ through RNG_{N}.

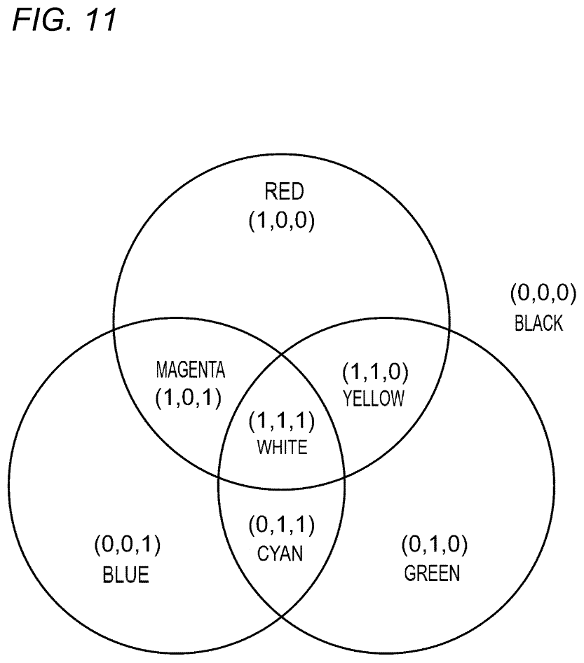

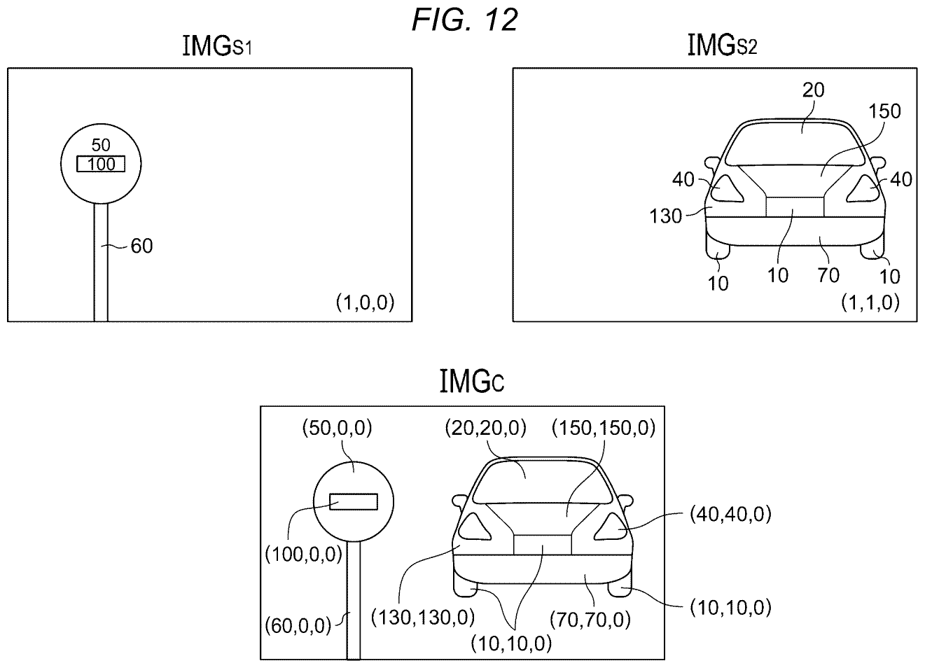

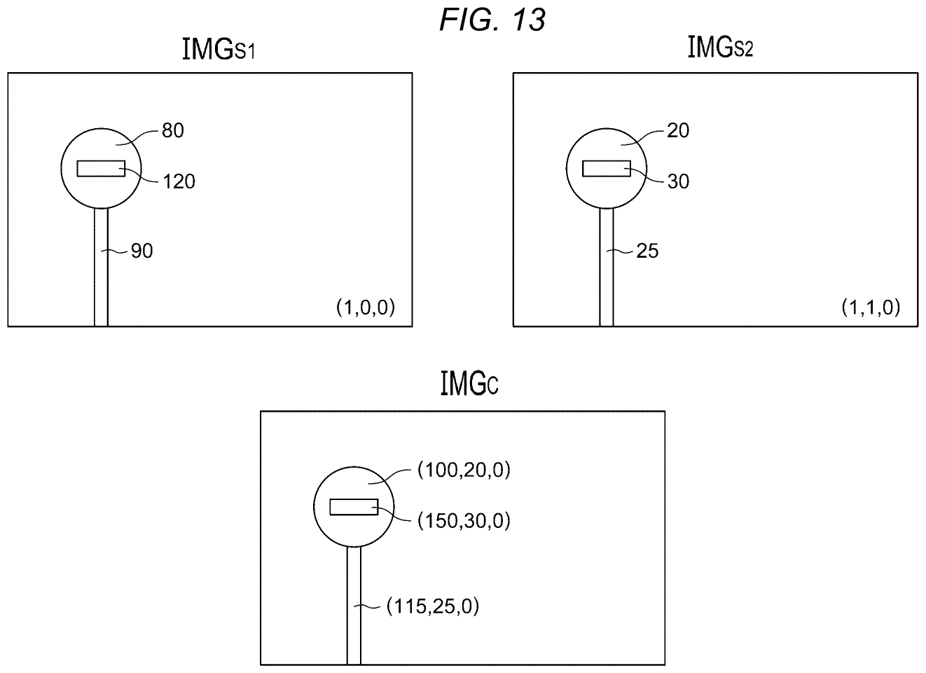

FIG. 11 is a diagram for explaining multiple colors assigned to multiple ranges in the RGB color system. For example, the following colors can be used as colors that correspond to the range. Red (1,0,0) Yellow (1,1,0) Green (0,1,0) Cyan (0,1,1) Blue (0,0,1) Magenta (1,0,1) The i-th (1≤i≤N) color (Rᵢ, Gᵢ, Bᵢ) and the (i+1)-th color (Rᵢ+1, Gi+1, Bi+1) have different values for one element from among R, G, and B. That is to say, the remaining two elements have the same value. In the chart shown in FIG. 11, two adjacent colors satisfy this relation. Description will be made in the present embodiment assuming that the elements (R, G, and B in this embodiment) of each color are normalized to 1.

In the case of red and yellow, two elements of R and B are equal, and one element of G has a different relation. In a comparison of green and cyan, the two elements R and G have the same relation and one element of B has a different relation.

For example, in a case in which the number N of the ranges is 6 or less, one from among the six colors of red to magenta may preferably be used as the number N of the colors that are adjacent to each other. It should be noted that description will be made assuming that magenta and red are adjacent to each other.

In addition to the six colors exemplified above, white (1, 1, 1) and black (0, 0, 0) may be used. White (1, 1, 1) has a relation of only one element different from yellow, cyan, and magenta. Black (0, 0, 0) has a relation of only one element different from red, green, and blue.

In a case in which the number N of the ranges is larger than 6, an intermediate color can be used. For example, a color (1, X, 0) can be defined between red (1, 0, 0) and yellow (1, 1, 0). However, 0<X<1 may be satisfied. For example, X=0.5 may be employed. When even more m colors are required, the colors (1, α₁, 0), (1, αₘ, 0) (1, αₘ, 0) may be used. Here, 0<α₁>α₂<<αₘ<1.

Similarly, a color can be determined between yellow and green, green and cyan, cyan and blue, and blue and magenta.

The pixel values (R, G, B) of each pixel of the combined image IMGc are represented by the following Expression using the pixel values v of the corresponding pixels of the multiple slice images.

(R, G, B)=Σ_{j=1:N}[vⱼ·(Rⱼ, Gⱼ, Bⱼ)].

FIG. 12 is a diagram for explaining the combining of the combined images IMGc. As described above, in the theory of a gating camera, an arbitrary object point (object) appears only in a slice image that corresponds to the range in which the object exists. In this case, when a given pixel of a given slice image has a non-zero pixel value, the pixel value of the pixel of a different slice image is zero.

FIG. 12 shows two slice images IMGs₁, IMGs₂, and combined image IMGc that correspond to the two ranges RNG₁ and RNG₂. Description will be made assuming that red (1, 0, 0) is assigned to the first range RNG₁, and yellow (1, 1, 0) is assigned to the second range RNG₂.

In the case in which a slice image IMGs₁ and IMGs₂ are 8-bit monochrome IR images, the pixel values of the respective pixels are represented by 256 gradations from 0 to 255. The numbers in the slice images IMGs₁ and IMGs₂ shown in FIG. 12 represent the pixel values for each region.

The slice image IMGs₁ is colored in red by multiplying the pixel values of the respective pixels by (1, 0, 0). That is to say, objects existing in the range RNG₁ in the combined image IMGc are represented by black (0, 0, 0) through red (1, 0, 0).

Similarly, the slice image IMGs₂ is colored yellow by multiplying the pixel values of the respective pixels by (1, 1, 0). That is to say, objects existing in the range RNG₂ in the combined image IMGc are represented by black (0, 0, 0) to yellow (1, 1, 0).

In this way, in the combined image IMGc, the color system represents the range. The brightness within the same color system represents the reflection ratio of the object.

In some cases, an object point existing in the vicinity of the boundary of the range is captured across two adjacent slice images. In this case, the same pixel of the two slice images has a non-zero pixel value. Also, in a case in which adjacent ranges are defined so as to overlap in the depth direction, the same pixel of the two slice images has a non-zero pixel value.

FIG. 13 is a diagram for explaining combining processing in a case in which the same object is captured across multiple slice images. In this embodiment, the two slice images IMGs₁ and IMGs₂ include the same marker. Directing attention to the pole of the indicator, the pixel value of the slice image IMGs₁ is 90, and the pixel value of the slice image IMGs₂ is 25. In this case, the pixel value of the pole in the combined image IMGc is represented by 90×(1, 0, 0)+25 ×(1, 1, 0)=(115, 25, 0).

Directing attention to the central square part of the sign, the pixel values of the slice image IMGs₁ are 120, and the pixel values of the slice image IMGs₂ are 30. In this case, the pixel value of the rectangular portion at the center of the sign in the combined image IMGc is 120×(1, 0, 0)+30×(1, 1, 0)=(150, 30, 0).

As described above, an object that is captured across the two slice images IMGs can be represented by multiple gradations using a color obtained by blending the two colors (1, 0, 0) and (1, 1, 0). This allows the contents of the sign to be identified.

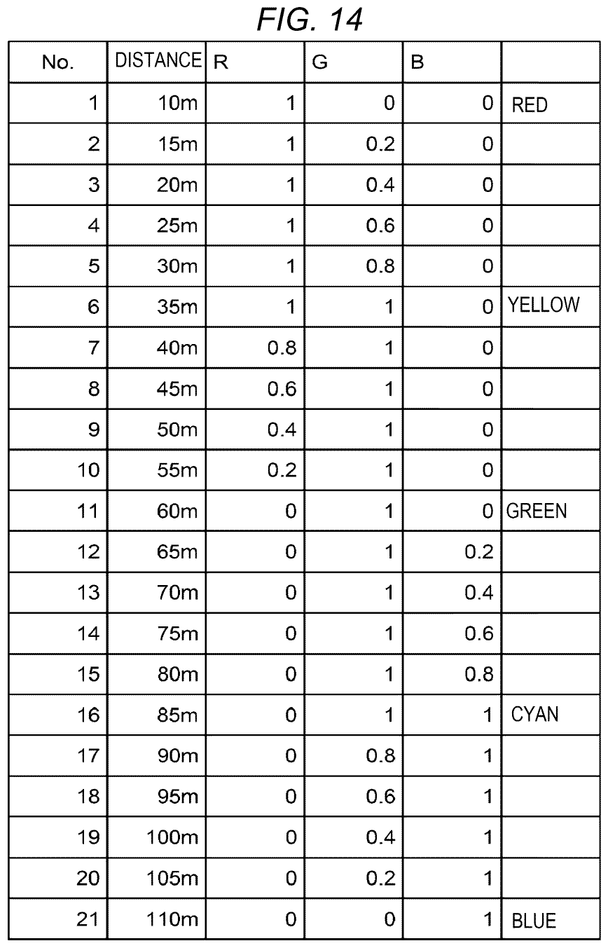

FIG. 14 is a diagram showing an example of the correspondence relation between multiple ranges and colors in Example 2.1. Description will be made regarding an arrangement in which the field of view having a depth of 10 m to 110 m is divided into N=21 regions of 5 m in each range, and an image is captured. The range RNG₁ is from 10 to 15 m, and red (1, 0, 0) is assigned. The portion between red, yellow, green, cyan, and blue is divided into five portions, and an intermediate color is used. cl Example 2.2

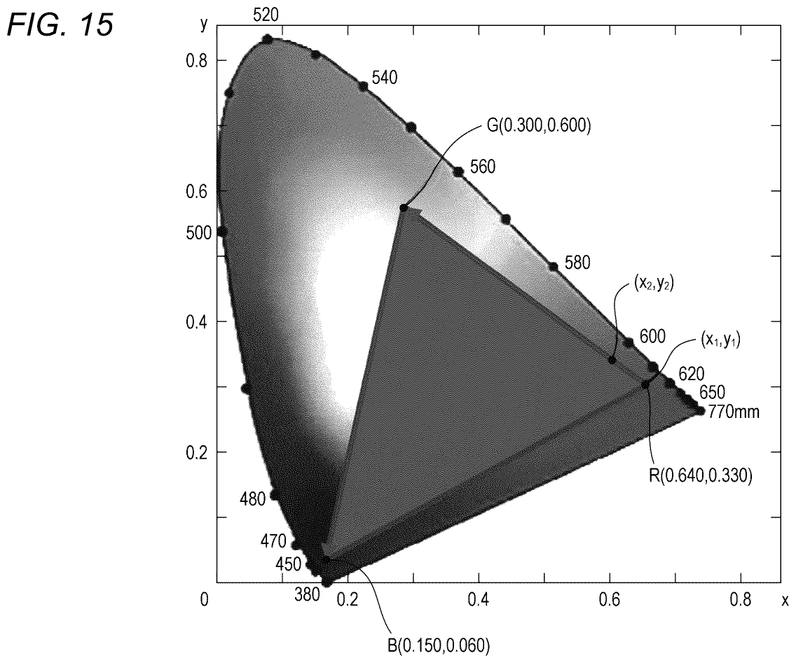

In Example 2.2, the Yxy color system (also referred to as the XYZ color system) is used. FIG. 15 is a diagram for explaining multiple colors assigned to multiple ranges in the Yxy color system. The color for the i-th range is defined as the chromaticity point (xᵢ, yᵢ) on the xy chromaticity diagram without using the brightness yin the Yxy color system.

As an example, the chromaticity points R (0.640, 0.330), G (0.300, 0.600), and B (0.150, 0.060) of sRGB according to the international standard may be used. Multiple chromaticity points positioned on the side (including the vertex) of a triangle having three points as vertices may be assigned to multiple ranges.

For example, multiple chromaticity points may be used that are positioned on two straight lines from R (0.640, 0.330) as a starting point, and toward B (0.150, 0.060) via G (0.300, 0.600).

The pixel values (Y, x, y) of the respective pixels of the combined image IMGc are represented by (Y, x, y)=(Σ_{j=1:N}(vⱼ), Σ_{j=1:N}(vⱼ·xⱼ)/Σ_{j=1:N}vⱼ, Σ_{j=1:N}(vⱼ·yⱼ)/Σ_{j=1:N}vⱼ). The brightness Y of the combined image IMGc is the sum of the pixel values of the slice images.

Description will be made regarding the chromaticity point (x, y) of each pixel of the combined image IMGc. Description will be made assuming that the chromaticity points (x₁, y₁) through (x_{N}, y_{N}) are assigned to the ranges RNG₁ through RNG_{N}, and that the pixels of the slice images IMGs₁ through IMGs_{N} have the pixel values of v₁ through V_{N}. In this case, the chromaticity point (x, y) of the same pixel of the combined image IMGc is represented by (x, y)=(Σ_{j=1:N}(vⱼ·xⱼ)/Σ_{j=1:N}vⱼ,

$${\sum }_{j = 1 : N} ( {v}_{j} \cdot {y}_{j} ) / {\sum }_{j = 1 : N} {v}_{j} ) = {\sum }_{j = 1 : N} \{ {v}_{j} \cdot ( {x}_{j} , {y}_{j} ) / {\sum }_{j = 1 : N} {v}_{j}$$

i.e., the chromaticity point (x, y) is obtained by weighting and adding (i.e., blending) the chromaticity points (x₁, y₁) through (x_{N}, y_{N}) of the multiple slice images using a coefficient based on the pixel values of the corresponding pixels.

For example, description will be made assuming that the chromaticity point (x₁, y₁)=(0.640, 0.330) of R is assigned to the range RNG₁, and the chromaticity point (x₂, y₂)=(0.606, 0.357) on a straight line from R to G is assigned to the next range RNG₂.

Description will be made assuming that the pixel values of the pixel of interest having the slice image IMGs₁ are 80, and the pixel values of the same pixel of interest in the slice image IMGs₂ are 160. In this case, the Y value of the pixel of interest in the combined image IMGc is set to 80+160=240.

Also, the chromaticity points (x, y) of the same pixel of the combined image IMGc are represented by (x, y)=80/(80+160)×(0.640, 0.330)+160/(80+160)×(0.606, 0.357)=(0.617, 0.348). This means that the two colors are blended in a ratio of 1:2. In the chromaticity diagram shown in FIG. 15, the chromaticity point of the combined image IMGc is a point obtained by internally dividing the two chromaticity points assigned to the slice image.

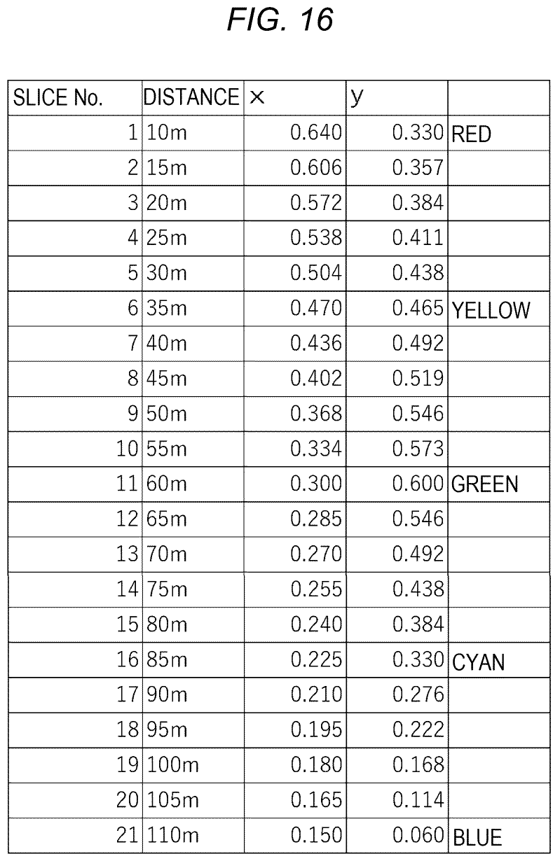

FIG. 16 is a diagram showing an example of the correspondence relation between multiple ranges and colors in Example 2.2.

### Example 2.3

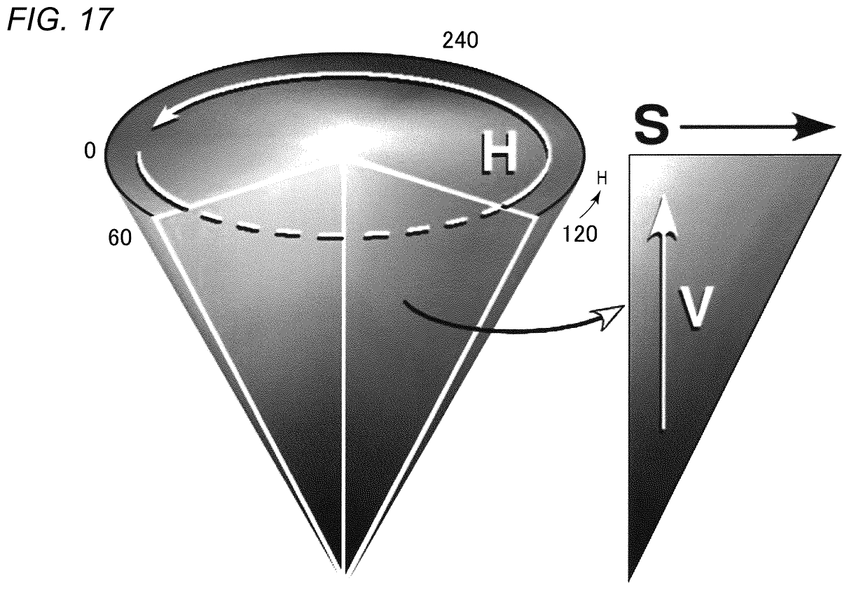

FIG. 17 is a diagram showing an example of the correspondence relation between multiple ranges and colors in Example 2.3. The N colors assigned to the N ranges are determined so as to have different hues H (Hue) in the HSV color system. The hue H may have a value of 0 to 360 degrees. The hue of the color assigned to the i-th range will be referred to as “Hᵢ”. Also, the Hᵢ may be determined as H₀+ixΔH. The H₀ and ΔH are constants.

The pixel values (H, S, V) of the respective pixels of the combined image IMGc are represented by (H, S, V)=(Σ_{j=1:N}(vⱼ·Hⱼ)/Σ_{j=1:N}vⱼ, S₀, Σ_{j=1:N}(vⱼ)). The S₀ may be defined as a constant. For example, the S₀ may be set to 100%.

The brightness V (Value) of the combined image IMGc is the sum of the pixel values of the slice image. The saturation S of each pixel of the combined image IMGc is a predetermined constant-S₀.

The hue H of each pixel of the combined image IMGc is obtained by weighting and adding the hue H₁ through H_{N} assigned to the multiple-slice images with the pixel value v.

For example, description will be made assuming that the hue H₁=0 is assigned to the range RNG₁, and the hue H₂=12 is assigned to the range RNG₂.

Description will be made assuming that the pixel values of the pixel of interest having the slice image IMGs₁ are 80, and the pixel values of the same pixel of interest in the slice image IMGs₂ are 160. In this case, the brightness V of the pixel of interest in the combined image IMGc is set to 80+160=240.

Furthermore, the hue H of the same pixel of the combined image IMGc is represented by H=80/(80+160)×0+160/(80+160)×12=8. This means that the two hues are blended in a ratio of 1:2. In the color space shown in FIG. 16, the hue H of the combined image IMGc is a point obtained by internally dividing the two hues assigned to the slice image.

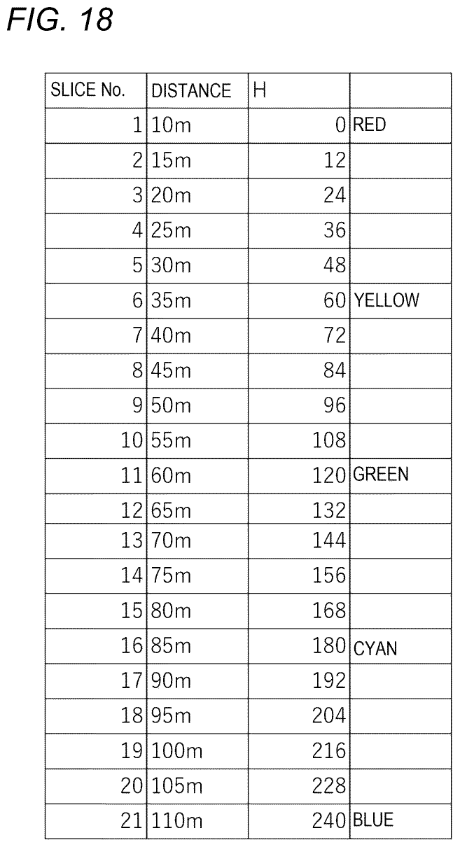

FIG. 18 is a diagram showing an example of the correspondence relation between multiple ranges and colors in Example 2.3. In this example, the hues are determined at ΔH=12 intervals for the 21 ranges.

### Third Embodiment

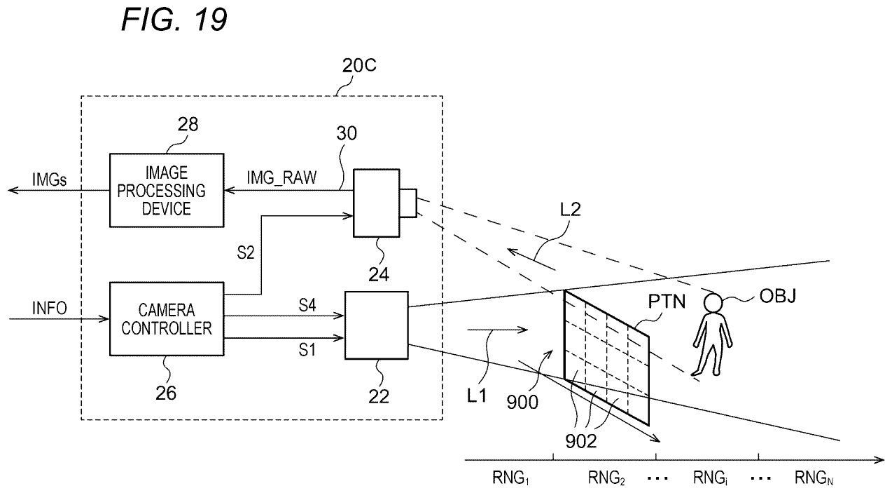

FIG. 19 is a block diagram showing a gating camera 20C according to an embodiment 3. The gating camera 20C is mounted on a vehicle such as an automobile, motorcycle, or the like. The output of the gating camera 20C is used to judge the kind (category or class) of an object OBJ that exists in the vicinity of the vehicle.

The gating camera 20B includes an illumination apparatus (light projector) 22, an image sensor 24, and a camera controller 26. The gating camera 20C captures images for a plurality of N (N≥2) ranges RNG₁ through RNG_{N} divided in the depth direction. The ranges may be designed such that adjacent ranges overlap at their boundaries in the depth direction.

The illumination apparatus 22 emits pulsed illumination light L1 in front of the vehicle in synchronization with a light emission timing signal S1 supplied from the camera controller 26. As the pulsed illumination light L1, infrared light is preferably employed. However, the present invention is not restricted to such configuration. Also, as the pulsed illumination light L1, visible light or ultraviolet light having a predetermined wavelength may be employed. As the illumination apparatus 22, for example, a laser diode (LD) or an LED can be used.

With the present embodiment, the illumination apparatus 22 is configured to divide the virtual vertical screen 900 into multiple regions 902, and to switch between the illumination and the non-illumination of the probe light L1 for each region, so as to allow the light distribution control. The light distribution control signal S4 that designates which region is to be irradiated with the probe light is input from the camera controller 26 to the illumination apparatus 22. The illumination apparatus 22 selects one region or multiple regions designated by the light distribution control signal S4, and irradiates the probe light L1 to the selected region (which is referred to as an illumination region) so as to form the light distribution pattern PTN.

The image sensor 24 includes multiple light-receiving pixels px, is capable of exposure control in synchronization with the exposure timing signal S2 supplied from the camera controller 26, and generates a raw image (RAW image) including multiple pixels. The image sensor 24 is sensitive to the same wavelength as that of the pulsed illumination light L1. The image sensor 24 captures an image of reflected light (returned light) L2 reflected by the object OBJ. The slice image IMGᵢ generated by the image sensor 24 with respect to the i-th range RNGᵢ is referred to as a raw image or a primary image as needed, and is distinguished from the slice image IMGsᵢ that is the final output of the gating camera 20C. The camera controller 26 controls the illumination timing (light emission timing) of the probe light L1 by the illumination apparatus 22 and the exposure timing by the image sensor 24. Specifically, the camera controller 26 is implemented as a combination of a processor (hardware component) such as CPU (Central Processing Unit), MPU (Micro Processing Unit), microcontroller, or the like, and a software program to be executed by the processor (hardware component).

The image processing device 28 receives the raw image IMG_RAWᵢ generated by the image sensor 24, and performs required image processing so as to generate slice-image IMGsᵢ. The slice image IMGs may be the same as that of the raw image IMG_RAW. In this case, the image processing device 28 may be omitted.

The camera controller 26 selects a region to be irradiated with the probe light L1 from among the multiple regions 902 on the virtual vertical screen 900 according to the driving situation of the vehicle on which the gating camera 20C is mounted, and generates the light distribution control signal S4.

The above is the configuration of the gating camera 20C. Next, description will be made regarding the operation of the sensing system 400.

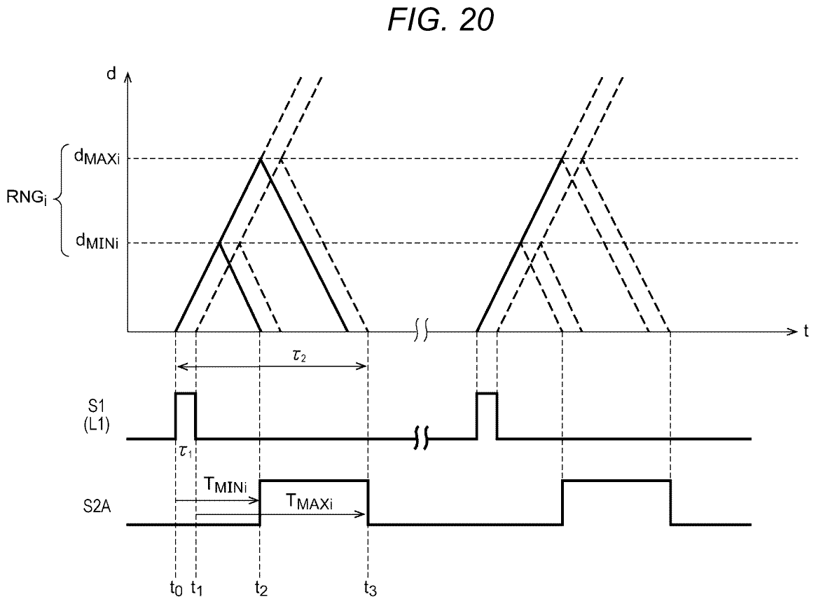

FIG. 20 is a diagram for explaining the basic operation of the gating camera 20C. FIG. 20 shows the operation when the i-th range RNGᵢ is sensed as a range of interest (ROI: Range Of Interest). The illumination apparatus 22 emits light during a light-emitting period Σ₁ from the time points to to t₁ in synchronization with the light emission timing signal S1. In the upper diagram of FIG. 7, a light beam diagram is shown with the horizontal axis as time and with the vertical axis as distance.

The distance between the gating camera 20 and the near-distance boundary of the range RNGᵢ is represented by d_{MINi}. The distance between the gating camera 20 and the far-distance boundary of the range RNGᵢ is represented by d_{MAXi}.

The round-trip time T_{MINi}, which is a period from the departure of light from the illumination apparatus 22 at a given time point, to the arrival of the light at the distance d_{MINi}, up to the return of the reflected light to the image sensor 24, is represented by T_{MINi}=2×d_{MINi}/c. Here, c represents the speed of light.

Similarly, the round-trip time T_{MAXi}, which is a period from the departure of light from the illumination apparatus 22 at a given time point, to the arrival of the light at the distance d_{MAXi}, up to the return of the reflected light to the image sensor 24, is represented by T_{MAXi}=2×d_{MAXi}/c.

When only an image of an object OBJ included in the range RNGᵢ is to be captured, the camera controller 26 generates the exposure timing signal S2 so as to start the exposure at the time point t₂=t₀+T_{MINi}, and so as to end the exposure at the time point t₃=t₁+T_{MAXi}. This is a single exposure operation.

When an image is captured for the i-th range RNGᵢ, multiple sets of light emission and exposure may be executed, and the pixels of the image sensor 24 may be integrated with the charges so as to generate a bright image. In this case, preferably, the camera controller 26 may repeatedly generate the light emission timing signal S1 and the exposure timing signal S2 with a predetermined period.

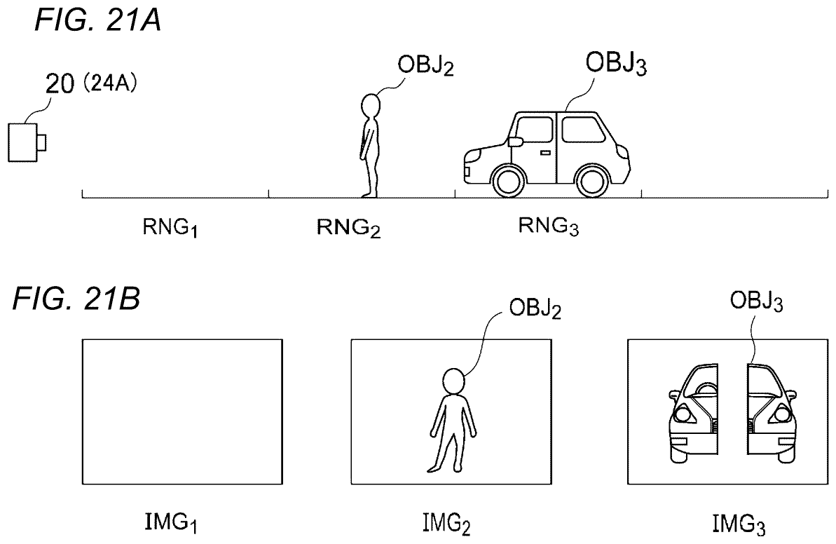

FIGS. 21A and 21B are diagrams for explaining slice images generated by the gating camera 20C. FIG. 21A shows an example in which an object (pedestrian) OBJ₂ exists in the range RNG₂, and an object (vehicle) OBJ₃ exists in the range RNG₃. FIG. 21B shows multiple range images IMG₁ through IMG₃ acquired in the situation shown in FIG. 21A. When the slice image SIMG₁ is captured, the image sensor is exposed by only the reflected light from the range RNG₁. Accordingly, the image SIMG₁ includes no object image.

Similarly, when the slice image SIMG₂ is captured, the image sensor is exposed by only the reflected light from the range RNG₂. Accordingly, the slice image SIMG₂ includes only the object OBJ₂. Similarly, when the slice image IMG₃ is captured, the image sensor is exposed by only the reflected light from the range RNG₃. Accordingly, the slice image IMG₃ includes only the object OBJ₃. As described above, with the gating camera 20, objects are separated and captured for the respective ranges.

Next, description will be made regarding the control of the illumination region according to the driving situation.

In some cases, depending on the driving situation, a region in the field of view that no object to be detected can exist may be fixedly generated. Representative examples of such ranges are sky. Also, depending on the driving situation, it is assumed that an object existing in a specific region of the field of view cannot affect the driving of the own vehicle. With the present embodiment, in such a range, by stopping the illumination of the probe light, this allows the power consumption to be reduced.

Furthermore, the image sensor 24 is not required to capture an image in a region where the probe light is not emitted. In order to solve such a problem, the camera controller 26 may change the image capture range (read-out range) of the image sensor 24 in conjunction with the light distribution of the probe light. This allows power consumption of the image sensor 24 to be reduced. Furthermore, this allows the image data to be read out and the transfer time to be shortened, thereby allowing the frame rate to be improved.

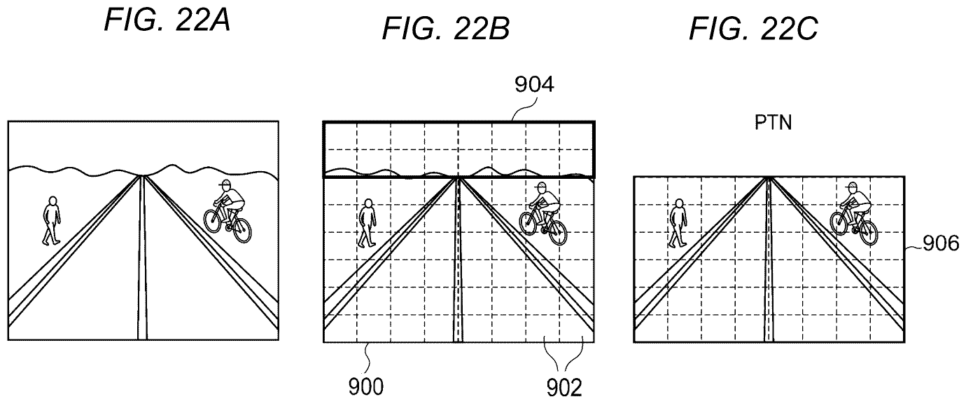

FIGS. 22A through 22C are diagrams for explaining an example of the control of the illumination region according to the driving situation. FIG. 22A shows the field of view in a given driving situation. FIG. 22B is a diagram showing the field of view shown in FIG. 22A in such a manner as to overlap with a virtual vertical screen 900 divided into multiple regions. In this driving situation, the upper side of the field of view is occupied by the sky. In this range, it is unlikely that a different vehicle, pedestrian, sign, or the like exist in a detection target by the gating camera 20C .

In this example, the range 904 of the virtual vertical screen 900 is a portion that corresponds to the sky. FIG. 22C shows the light distribution pattern PTN of the probe light L1. The region 904 that corresponds to the sky is excluded from the probe light illumination region 906. As a consequence, the slice images IMGs₁ through IMGs_{N} captured by the gating camera 20C include an image of an object existing in a part other than the sky.

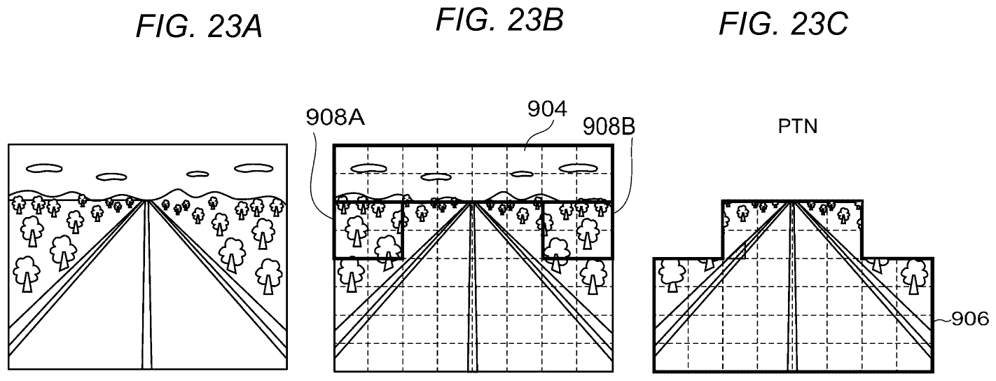

FIGS. 23A through 23C are diagrams for explaining another example of the control of the illumination region according to the driving situation. FIG. 23A shows a field of view in a driving situation. FIG. 23B is a diagram showing the field of view shown in FIG. 23A in such a manner as to overlap with a virtual vertical screen 900 divided into multiple regions. FIG. 23C shows the light distribution pattern PTN of the probe light L1 in the driving situation shown in FIG. 23A.

Depending on the driving situation, it is assumed that an object existing in a specific partial range of the field of view cannot affect the driving of the own vehicle. FIG. 23A is an example of a field of view. This example shows that only natural objects such as trees exist outside the road. In this case, it can be said that an object existing outside the road has a low degree of interest. The same can be said of a case in which only an artificial object such as a building exists outside the road. In another example, both sides of a road are covered with a guardrail or a side wall. Also, in a driving situation in which an object outside the guardrail or the side wall cannot enter the road, the degree of interest in the object existing in the region outside the road is low.

In this example, the range 904 of the virtual vertical screen 900 is a portion that corresponds to the sky. Also, the ranges 908A and 908B indicate the outside of the road.

In this driving situation, as shown in FIG. 23C, the range 904 that corresponds to the sky and the ranges 908A and 908B outside the road are excluded from the probe light illumination region 906. As a consequence, the slice images IMGs₁ through IMGs_{N} captured by the gating camera 20C include an image of an object existing in a part other than the sky and the street.

As another example of control, description will be made assuming that the vehicle is traveling on the left side in the driving situation shown in FIG. 22A. In this case, in some cases, it is difficult to think that an object (bicycle in this example) outside the road on the oncoming lane side immediately affects the driving of the automobile. FIG. 22A shows one lane on the one side. However, in the case of two lanes on the one side, this tendency increases particularly. In such a driving situation, a region outside the road on the oncoming lane side may be eliminated from the probe light illumination region.

With the above-described probe light distribution control, it is required to appropriately recognize a driving situation. The camera controller 26 may control the light distribution of the probe light based on the slice images IMGs₁ through IMGs_{N} captured by the gating camera 20C.

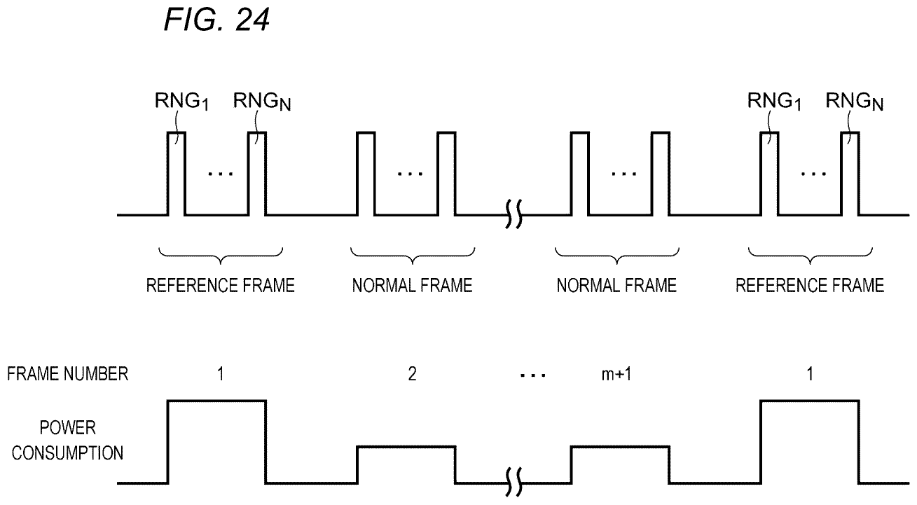

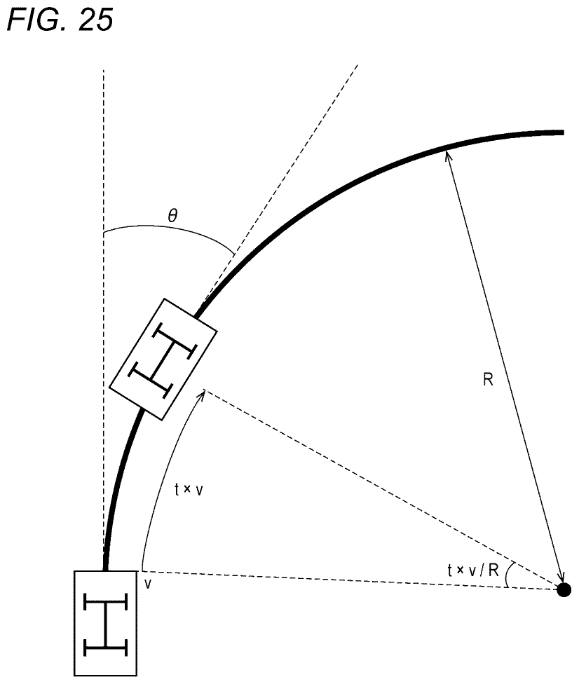

FIG. 24 is a diagram for explaining the light distribution control by the camera controller 26. The camera controller 26 alternately repeats the reference frame REF and the normal frame covering the m frames (m≥1) that follow the reference frame REF. The reference frame and the normal frame each include sensing for all the ranges.

In the reference frame REF, all the regions are irradiated and the entre field of view is with probe light. The camera controller 26 judges the driving situation based on the slice images IMGs₁ through IMGs_{N} generated in the reference frame REF, and determines the light distribution of the probe light.

As for a portion that corresponds to the sky, in principle, there is no object that reflects the probe light L1. Accordingly, the pixel values of the sky portion are extremely small for all the slice images IMGs₁ through IMGs_{N} acquired for the multiple ranges RNG₁ through RNG_{N}. Accordingly, the camera controller 26 may judge a portion of the image on the upper side, which is smaller than a predetermined threshold value, to be sky for all the slice images IMGs₁ through IMGs_{N}.

The light distribution pattern determined based on the slice image of the reference frame REF is used, and the sensing is repeated as a normal frame for the next m frames.

The power consumption becomes large during the reference frame. During the normal frame, the power consumption becomes small according to the driving situation. With this operation being repeated, the gating camera 20C is capable of forming light distribution suitable for a driving situation, thereby allowing power consumption to be reduced.

The region 908 outside the road may be judged based on the slice images IMGs. However, in this case, such a case requires high-level image processing. In order to solve such a problem, the region 908 outside the road may be judged with reference to the map information. For example, in a case in which high-precision three-dimensional map information is available, the camera controller 26 is capable of accurately reproducing the field of view in each driving situation. Accordingly, the judgment of the region 908 outside the road is easy. The light distribution control that is not based on the slice image (e.g., that is based on three-dimensional map information) may be executed in the reference frame or in the normal frame.

Here, the power consumption of the gating camera 20C becomes larger in the reference frame. Accordingly, as the frequency of generation of the reference frame becomes lower, in other words, as the value m becomes larger, the effect of reducing the power consumption becomes larger. On the other hand, in a case in which m is excessively increased, there is a possibility that a difference occurs between the current driving situation in the normal frame and the past driving situation in the reference frame. This leads to an inappropriate light distribution for the probe light. In order to solve such a problem, the gating camera 20C may dynamically control the parameter m according to the road condition.

For example, the camera controller 26 may reduce m in the vicinity of a slope. In the vicinity of a slope, the proportion of sky included in the field of view of the camera changes greatly and frequently. Accordingly, in such a situation, by reducing m and frequently updating the light distribution of the probe light, appropriate sensing is enabled. Whether or not the vehicle is in the vicinity of the slope may be judged based on the three-dimensional map information. Alternatively, the judgment may be made based on the output of an inclination sensor (acceleration sensor) mounted on the vehicle.

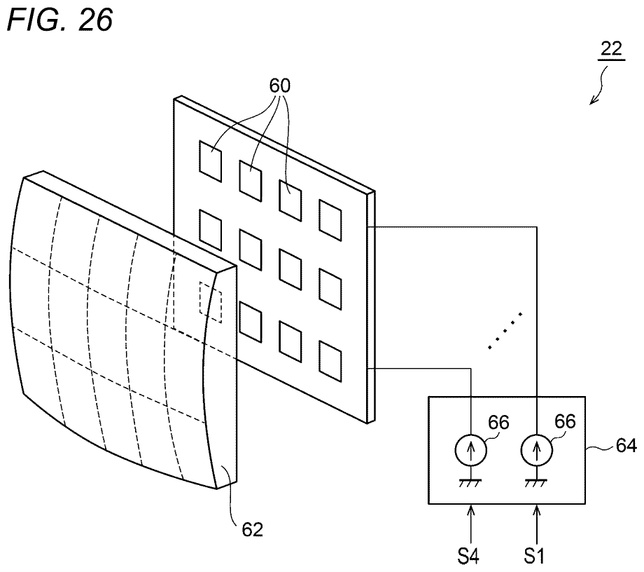

In a slope, the field of view in the up-down direction changes greatly. In contrast, in a curve, the field of view in the left-right direction changes greatly. In order to solve such a problem, the upper limit of m may be determined giving consideration to the curve. FIG. 25 is a diagram for explaining the change of the horizontal field of view while the vehicle is traveling on the curve. When the vehicle travels at a maximum speed of 120 km/h with a curved radius R=710 m (assumed minimum curve), the field of view changes by 2.68 degrees, 0.26 degrees, 0.13 degrees, 0.054 degrees, and 0.027 degrees in 1 second, 0.1 second, 0.05 second, 0.02 seconds, and 0.01 second respectively. When the change of the field of view is about 0.26 degrees, it can be said that the sky position hardly changes. In order to solve such a problem, the upper limit of m may be determined so as to generate a reference frame for at least every 0.1 second.

More highly, the camera controller 26 may dynamically control the occurrence intervals of the reference frames m based on the radius of curvature of the curve on which the vehicle is traveling. Description will be made with the vehicle speed as v, the radius of curvature as R, and the allowable change range of the field of view of a given reference frame and the subsequent reference frame as θ_{MAX} (rad). Description will be made with the upper limit of the time interval of the reference frame as the t_{MA}X, which satisfies the following relational expression.

$${θ}_{MAX} = v \cdot {t}_{MAX} / 2 R$$

The upper limit of the time interval of the reference frame is represented by t_{MAX}=2R·θ_{MAX}/v. That is to say, the upper limit of the time interval of the reference frame may be changed so as to be proportional to the radius of curvature R and inversely proportional to the vehicle speed v.

Next, description will be made regarding the configuration of the illumination apparatus 22. FIG. 26 is a diagram showing an example of the configuration of the illumination apparatus 22. The illumination apparatus 22 includes multiple semiconductor light emitting elements 60, an optical system 62, and a lighting circuit 64. The multiple semiconductor light emitting elements 60 are arranged in an array. The array may be configured as a one-dimensional array or a two-dimensional array. As the semiconductor light emitting element 60, an LD (laser diode) is preferably used. However, an LED (light emitting diode) or an organic EL (Electro Luminescence) element may be used.

The optical system 62 projects the output light of each of the multiple semiconductor light emitting elements 60 onto a corresponding one from among the multiple regions on the virtual vertical screen. The configuration of the optical system 62 is not restricted in particular. The optical system 62 may be configured as an array of lenses or a light guide body provided with multiple steps.

The lighting circuit 64 selects the multiple semiconductor light emitting elements 60 to be driven according to the light distribution control signal S4. Then, the driving current is supplied to the selected semiconductor light emitting element 60 in synchronization with the light emission timing signal S1. Also, the lighting circuit 64 may include multiple constant current drivers 66 that correspond to the multiple semiconductor light emitting elements 60. Some constant current drivers 66 from among the multiple constant current drivers 66 are activated according to the light distribution control signal S4. The active constant current driver 66 generates a drive current in synchronization with the light emission timing signal S1.

Description will be made regarding a modification relating to the embodiment 3.

### Modification 3.1

Description has been made in the embodiment 3 regarding an arrangement in which the light distribution of the probe light is divided into two dimensions so as to be controlled. However, such an arrangement may be employed in which only the light distribution is divided in the vertical direction so as to exclude a sky portion.

### Modification 3.2

Alternatively, the control may not be executed so as to exclude the sky portion, and the control may be executed so as to exclude the road exclusion.

Next, description will be made regarding the usage of the gating cameras 20A through 20C (which will be collectively referred to as “gating camera 20” below) according to the embodiments 1 through 3.

### Usage

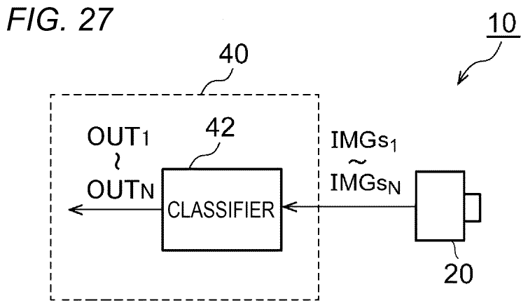

FIG. 27 is a block diagram showing the sensing system 10. The sensing system 10 includes a processing device 40 in addition to the gating camera 20 described above. The sensing system 10 is configured as an object detection system mounted on a vehicle such as an automobile, motorcycle, or the like. The sensing system 10 determines the type (category or class) of objects OBJ existing around the vehicle.

The gating camera 20 generates multiple slice images IMG₁ through IMG_{N} that correspond to the multiple ranges RNG₁ through RNG_{N}. The i-th slice image IMGsᵢ includes only an image of an object included in the corresponding range RNGᵢ.

The processing device 40 is configured to identify the kind of the object based on a learned model generated by machine learning based on slice images IMGs₁ through IMGs_{N} that correspond to the multiple ranges RNG₁ through RNG_{N} generated by the gating camera 20. The processing device 40 is provided with a classifier 42 implemented based on a learned model generated by machine learning. Also, the processing device 40 may include multiple classifiers 42 optimized for the respective ranges. The algorithm employed by the classifier 42 is not restricted in particular.

Examples of algorithms that can be employed include YOLO (You Only Look Once), SSD (Single Shot Multi Box Detector), R-CNN (Region-based Convolutional Neural Network), SPPnet (Spatial Pyramid Pooling), Faster R-CNN, DSSD (Deconvolution-SSD), Mask RCNN, etc. Also, other algorithms that will be developed in the future may be employed.

Specifically, the processing device 40 may be implemented as a combination of a processor (hardware component) such as a CPU (Central Processing Unit), MPU (Micro Processing Unit), microcontroller, or the like, and a software program to be executed by the processor (hardware component). Also, the processing device 40 may be configured as a combination of multiple processors. Alternatively, the processing device 40 may be configured as a hardware component only. The functions of the image processing device 40 and the image processing device 28 may be provided as the same processor.

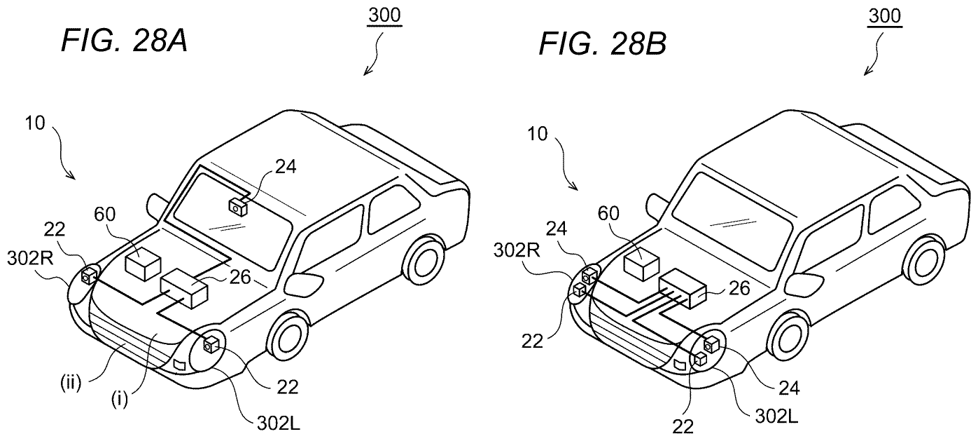

FIGS. 28A and 28B are diagrams showing an automobile 300 provided with the gating camera 20. FIG. 28A will be referred. The automobile 300 shown in FIG. 11A includes a single illumination apparatus 22 at a central position of the vehicle.

As shown in FIG. 28A, the illumination apparatus 22 of the gating camera 20 may be built into at least one from among the left and right headlamps 302L and 302R. The image sensor 24 may be mounted on a part of a vehicle, for example, on the back side of a rear-view mirror. Alternatively, the image sensor 24 may be provided to a front grille or a front bumper. The camera controller 26 may be provided in an interior of the vehicle or an engine compartment. Also, the camera controller 26 may be built into the headlamps 302L, 302R.

As shown in FIG. 28B, the image sensor 24 may be built into any one of the left and right headlamps 302L, 302R together with the illumination apparatus 22.

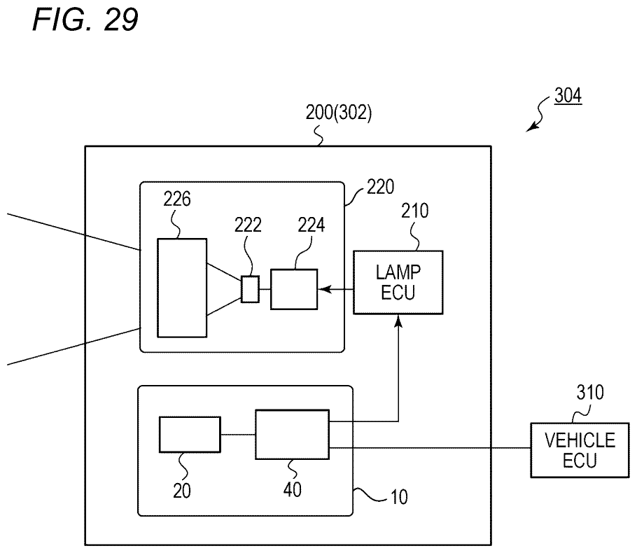

FIG. 29 is a block diagram showing a vehicle lamp 200 provided with the sensing system 10. The vehicle lamp 200 forms a lamp system 304 together with an in-vehicle ECU 310. The vehicle lamp 200 includes a lamp ECU 210 and a lamp unit 220. The lamp unit 220 is configured as a low beam unit or a high beam unit. The lamp unit 220 includes a light source 222, a lighting circuit 224, and an optical system 226. Furthermore, the vehicle lamp 200 includes the sensing system 10.

The information with respect to the object OBJ detected by the sensing system 10 may be used to support the light distribution control operation of the vehicle lamp 200. Specifically, the lamp ECU 210 generates a suitable light distribution pattern based on the information with respect to the type of the object OBJ and the position thereof generated by the sensing system 10. The lighting circuit 224 and the optical system 226 operate so as to provide the light distribution pattern generated by the lamp ECU 210. The processing device 40 of the sensing system 10 may be provided outside the vehicle lamp 200, i.e., on the vehicle side.

In addition, the information with respect to the object OBJ detected by the sensing system 10 may be transmitted to the in-vehicle ECU 310. The in-vehicle ECU 310 may use the information for self-driving or driving support.

The embodiments have been described for exemplary purposes only, showing one aspect of the principles and applications of the present invention. In addition, many modifications and variations can be made to the embodiments without departing from the spirit of the present invention as defined in the claims.

### INDUSTRIAL APPLICABILITY

The present invention relates to a gating camera.

### REFERENCE SIGNS LIST

S1 Light emission timing signal
S2 exposure timing signal
S3 Image capture range control signal
S4 Light distribution control signal
10 sensing system
20A Gating camera
20B Gating camera
20C Gating camera
22 illumination apparatus
24 image sensor
26 camera controller
40 processing device
42 classifier
60 semiconductor light emitting device
62 optical system
64 lighting circuit
200 vehicle lamp
210 lamp ECU
220 lamp unit
222 light source
224 lighting circuit
226 optical system
300 automobile
302 headlamp
304 lamp system
310 in-vehicle ECU

1-20. (canceled)

21. A gating camera configured to divide a field of view into multiple ranges in a depth direction, and to generate multiple slice images that correspond to the multiple ranges, the gating camera comprising:
an illumination apparatus configured to emit probe light, to include multiple light emitting elements, and to be capable of controlling a light distribution of the probe light by selecting the use or non-use of the multiple light emitting elements according to a light distribution control signal;
an image sensor configured to be capable of controlling exposure timing; and
a controller configured to (i) control the light emission timing of the illumination apparatus and timing of image capture by the image sensor for each range; and (ii) determine a region to be irradiated with the probe light according to a driving situation, and generate the light distribution control signal.

22. The gating camera according to claim 21, wherein the controller excludes a region that corresponds to a sky from the region to be irradiated with the probe light.

23. The gating camera according to claim 21, wherein the controller excludes a region outside the road from the region to be irradiated with the probe light.

24. The gating camera according to claim 21, wherein the controller selects all the regions as the region to be irradiated with the probe light in a reference frame, and determines the region to be irradiated with the probe light in m (m≥1) normal frames following the reference frame based on the multiple slice images obtained in the reference frame.

25. The gating camera according to claim 24, wherein the controller judges an area in which pixel values are smaller than a predetermined threshold value in all the slice images captured in the reference frame as a region that corresponds to sky.

26. The gating camera according to claim 21, wherein the controller selects the region to be irradiated with the probe light based on three-dimensional map information.

27. The gating camera according to claim 24, wherein the controller dynamically controls m, which is an interval at which the reference frame is generated, according to a road condition.

28. The gating camera according to claim 27, wherein the controller reduces m in the vicinity of a slope.

29. The gating camera according to claim 27, wherein the controller controls an upper limit of an interval of occurrence of the reference frame or an interval of occurrence of the reference frame based on a radius of curvature of the curve on which the vehicle is traveling.

30. A sensing system for a vehicle comprising the gating camera according to claim 21.

31. A vehicle lamp comprising the gating camera according to claim 21.

32. An illumination apparatus for a gating camera configured to divide a field of view into multiple ranges in a depth direction, and to generate multiple slice images that correspond to the multiple ranges, the illumination apparatus comprising:
multiple light emitting elements arranged in an array;
an optical system configured to project an output light of each of the multiple light emitting elements into a corresponding one from among multiple regions on a virtual vertical screen; and
a lighting circuit configured to be capable of selectively driving the multiple light emitting elements and to be capable of controlling driving timing of the multiple light emitting elements according to a light emission timing signal.
